(19) United States
(12) Patent Application Publication
(10) Pub. No.: US 2015/0227148 A1
(43) Pub. Date: Aug. 13, 2015

(54) ENERGY MANAGEMENT SYSTEM, ENERGY MANAGEMENT METHOD, AND SERVER DEVICE AND TERMINAL DEVICE THAT USE ENERGY MANAGEMENT METHOD

(71) Applicant: NEC Corporation, Tokyo (JP)

(72) Inventors: Rie Tanaka, Tokyo (JP); Satoko Itaya, Tokyo (JP); Naoki Yoshinaga, Tokyo (JP); Shinichi Doi, Tokyo (JP); Taku Konishi, Tokyo (JP)

(73) Assignee: NEC Corporation, Tokyo (JP)

(21) Appl. No.: 14/422,784

(22) PCT Filed: Aug. 21, 2013
(86) PCT No.: PCT/JP2013/004947

§ 371 Date: Feb. 20, 2015

(30) Foreign Application Priority Data
Aug. 23, 2012 (JP) 2012-183744

(51) Int. Cl. G05F 1/66; G05B 15/02

(52) U.S. Cl. CPC G05F 1/66; G05B 15/02

(57) ABSTRACT

An energy management system for a facility having a plurality of pieces of equipment that consume energy, the energy management system being provided with: an equipment information storage device for storing equipment information pertaining to equipment utilization; an action history storage device for storing historical information on the actions of the equipment users; and a recommendation content decision unit for calculating, on the basis of the equipment information and the action history information, actions pertaining to equipment utilization that will lead to a reduction in the amount of energy consumed at the facility, and deciding on recommendation content that includes actions for the users.

### TECHNICAL FIELD

The invention relates to an energy management system, an energy management method, and a server device and a terminal device using the energy management method, which recommend a specific action to a user in order to reduce electric power consumption of a facility.

### BACKGROUND ART

Requirement for energy saving in various facilities of a city increases due to recent energy shortage and restriction, or managerial cost-cutting. In the saving energy described in following explanations, various resources including electricity, gas, tap water, etc. are saving targets.

For example, in each home, a subject who requires energy saving is same as a subject who actually uses energy. In a theme park, a hotel or an amusement facility, etc., a subject who requires energy saving is different from a subject who actually uses energy.

In a facility in which an administrator who is a subject who requires energy saving of the facility is different from a user who is a subject who uses the facility, the administrator demands energy saving as much as possible and the facility user demands service which is worth paid usage fee. It may be difficult to satisfy both an administrator's demand and a user's demand. The energy saving carried out by the administrator is limited, since there is a possibility the user does not come to the facility anymore if the user's demand is neglected and energy saving is unilaterally carried out. Therefore, an energy saving mechanism is necessary in which both the user's demand and the administrator's demand are taken into consideration.

Patent Literature 1 discloses the electric power management system recommending an action which satisfies a user's demand.

The electric power management system of Patent Literature 1 shown in FIG. 17 includes an integrated management panel 171, a center server 173, and a control panel 174. An inhabitant, as an electric power user, can confirm an energy saving plan shown on the integrated management panel 171 through the control panel 174. The energy saving plan is set by the integrated management panel 171 on the basis of electric power usage conditions of the inhabitant. Therefore the inhabitant can easily perform energy saving actions by carrying out the energy saving plan.

Patent Literature 2 discloses the recommend device estimating and recommending, at the time of purchasing, commodities which may be bought next time on the basis of a past purchase behavior history of a user.

The recommend device of Patent Literature 2 includes a recommend unit 180. A maximum commodity selection unit 188 receives an input data 181 from an input data reading unit 185, prior probability 182 and Gap Markov Model 183 from an extended Markov Model reading unit 186, and weight 184 from a weight reading unit 187. The maximum commodity selection unit 188 selects a commodity number based on a user purchase history, using the inputted data, and outputs the commodity number to a recommend output unit 189. The recommend output unit 189 exhibits the selected commodity number to the user. In the recommend device of Patent Literature 2 estimates, based on the Markov Model, a commodity which is likely to be successively purchased after purchasing a predetermined commodity by using the purchase histories of a plurality of users. By using the estimation result, the commodity which is likely to be successively purchased by a user after purchasing a predetermined commodity is selected, and information of the commodity is given to the user.

Patent Literature 3 discloses the air conditioning management system which achieves energy saving in accordance with an administrator's demand.

The air conditioning management system in Patent Literature 3 shown in FIG. 19 includes an air conditioning management device 191, a setter 192, and an electric power integrating device 193. The air conditioning management device 191 can automatically control operations of a plurality of air conditioning apparatuses (indoor unit 195 in FIG. 19) in an integrated manner, and calculates a future air conditioning consumption amount on the basis of past air conditioning usage data. A user can usually control a plurality of air conditioning apparatuses. Automatic restriction of driving condition for energy saving on the basis of a parameter given by the setter 192 and a signal given by the electric power integrating device 193 is given priority over user's instruction. Therefore when the future air conditioning consumption amount based on the past air conditioning usage data is larger than the past air conditioning consumption amount, automatic control of an air conditioning apparatus by the air conditioning management device 191 has a priority, and control of the air conditioning apparatus by a user is automatically restricted.

Patent Literature 4 discloses an environment management apparatus 200 which assists electric power saving by an administrator while considering a user's action.

The environment management apparatus 200 shown in FIG. 4 acquires an environmental condition of a predetermined zone in a store by an environmental information acquiring unit 201, and information on a visitor located in the predetermined zone by a visitor information acquiring unit 203. An environmental management information generating unit 206 generates environmental management information on the basis of information acquired by the environmental information acquiring unit 201 and the visitor information acquiring unit 203. The environmental management information includes an instruction to store staff in the store. The environmental management information is displayed on a display device 223 in accordance with control of a display control unit 217. The store staff sets environment in the store in response to the instruction included in the environmental management information displayed on the display device 223. According to the environment management apparatus 200 of Patent Literature 4, it is possible to instruct the number of visitors, attributes of visitors, and arrangement to store staff of stores such as a restaurant, and it is possible for the store stuff to adjust electric apparatuses in accordance with the instruction.

### CITATION LIST

### Patent Literature

### Patent Literature 1

### Japanese Patent Application Laid-Open No. 2009-259125

### Patent Literature 2

### Japanese Patent No. 4847916

### Patent Literature 3

### Japanese Patent No. 4270929

### Patent Literature 4

### Japanese Patent Application Laid-Open No. 2011-187031

### SUMMARY OF INVENTION

### Technical Problem

According to Patent Literature 1, though probability that a visitor carries out the instructed action is increased, environment in which energy saving motivation of a visitor, such as electric power saving in a home where the visitor is living, is easily increased, is premised. In a facility in which an administrator who wants energy saving of the facility is different from a visitor using the facility, the effect of Patent Literature 1 is not necessarily acquired.

According to Patent Literature 2, probability that a user carries out a recommended action is increased. However cost of another aspect such as energy usage generated thereby is not considered. The recommend device of Patent Literature 2 does not lead to energy saving of electric power.

According to Patent Literature 3, only demand of an administrator is satisfied and a user's demand is not reflected.

According to Patent Literature 4, though energy saving is achieved without noticing a user, a range of electric power saving is limited since a user freely behaves in a store and an administrator carried out electric power control in accordance therewith.

An object of the invention is to recommend an action which leads to energy saving of a facility which is an administrator's demand to a user, and to increase probability that the recommended action content satisfies a user's demand and is carried out. Consequently an energy management system, an energy management method, and a server device and a terminal device using the energy management method are provided.

### Solution to Problem

An energy management system of the invention is an energy management system of a facility including a plurality of pieces of equipment that consume energy, and includes an equipment information storage device for storing equipment information pertaining to equipment utilization, an action history storage device for storing action history information of an equipment user, and a recommendation content decision means for calculating, on the basis of the equipment information and the action history information, an action pertaining to the equipment utilization that leads to a reduction in energy consumption at the whole facility, and deciding on recommendation content including the action for the user.

A server device of the invention is a server device that performs energy management of a facility comprising a plurality of pieces of equipment that consume energy, and includes an equipment information storage device for storing equipment information pertaining to equipment utilization, an action history storage device for storing action history information of an equipment user, and a recommendation content decision means for calculating, on the basis of the equipment information and the action history information, an action pertaining to the equipment utilization that leads to a reduction in energy consumption at the facility, and deciding on recommendation content including the action for the user.

An energy management method of the invention is an energy management method of facility including a plurality of pieces of equipment that consume energy, and includes storing equipment information pertaining to equipment utilization, storing action history information of an equipment user, and calculating, on the basis of the equipment information and the action history information, an action pertaining to the equipment utilization that leads to a reduction in energy consumption at the facility, and deciding on recommendation content including the action for the user.

### Advantageous Effects of Invention

According to the invention, since an action which leads to energy saving of a facility which is an administrator's demand is coordinated with a user's demand and is recommended after that, probability is increased, that the recommended action satisfies the user's demand and is carried out. Consequently when the user takes the recommended action, energy saving of the whole facility can be achieved.

### BRIEF DESCRIPTION OF DRAWINGS

FIG. 1 a block diagram illustrating a configuration of an energy management system of a first embodiment of the invention,

FIG. 2 a block diagram illustrating details of a recommendation content decision means which is a calculation process part deciding on information to be recommended to a user, in the energy management system of the first embodiment of the invention,

FIG. 3 a flowchart for explaining a flow of processes of the energy management system of the first embodiment of the invention,

FIG. 4 a block diagram illustrating a configuration of an energy management system of a second embodiment of the invention,

FIG. 5 a block diagram illustrating a configuration of an energy management system of a third embodiment of the invention,

FIG. 6 an example of data stored in an equipment information storage device of an exemplary embodiment 1 of the invention,

FIG. 7 an example of data stored in an energy saving method storage device of the exemplary embodiment 1 of the invention,

FIG. 8 an example of data indicating a past action content of a user, which is stored in an action history storage device of the exemplary embodiment 1 of the invention,

FIG. 9 an example of an action candidate which is recommended to a user, which is stored in an action candidate storage device of the exemplary embodiment 1 of the invention,

FIG. 10 an example of data relating a facility, an action content and usage time to each other, which is stored in an equipment utilization information storage device of the exemplary embodiment 1 of the invention,

FIG. 11 an example of correspondence table which relates a user, equipment, probability of an action carried out in the equipment to each other, which is made in a calculation process of an action decision means of the exemplary embodiment 1 of the invention,

FIG. 12 an example of data indicating a content of an action and a place to be recommended to a user, which is decided on by an action decision means of the exemplary embodiment 1 of the invention,

FIG. 13 an example of data indicating a content which is recommended to a user and presence or absence of an action, which is stored in an action history storage device related to the exemplary embodiment 1 of the invention,

FIG. 14 an example of data which is stored in an individual characteristic storage device related to an exemplary embodiment 2 of the invention,

FIG. 15 an example of data of a result analyzed by a situation analysis means of the exemplary embodiment 2 of the invention,

FIG. 16 an example of data indicating a plan which is stored in a stay plan storage device of the exemplary embodiment 2 of the invention,

FIG. 17 a block diagram illustrating a configuration of an electric power management system of Patent Literature 1,

FIG. 18 a block diagram illustrating a configuration of a recommendation device of Patent Literature 2,

FIG. 19 a block diagram illustrating a configuration of an air conditioning management system of Patent Literature 3,

FIG. 20 a block diagram illustrating a configuration of an environment management apparatus of Patent Literature 4,

### DESCRIPTION OF EMBODIMENTS

### First Embodiment

Next a first embodiment 1 of the invention is described in detail by referring to drawings. Descriptions on following embodiments are examples of the invention and do not limit the invention.

### (Configuration)

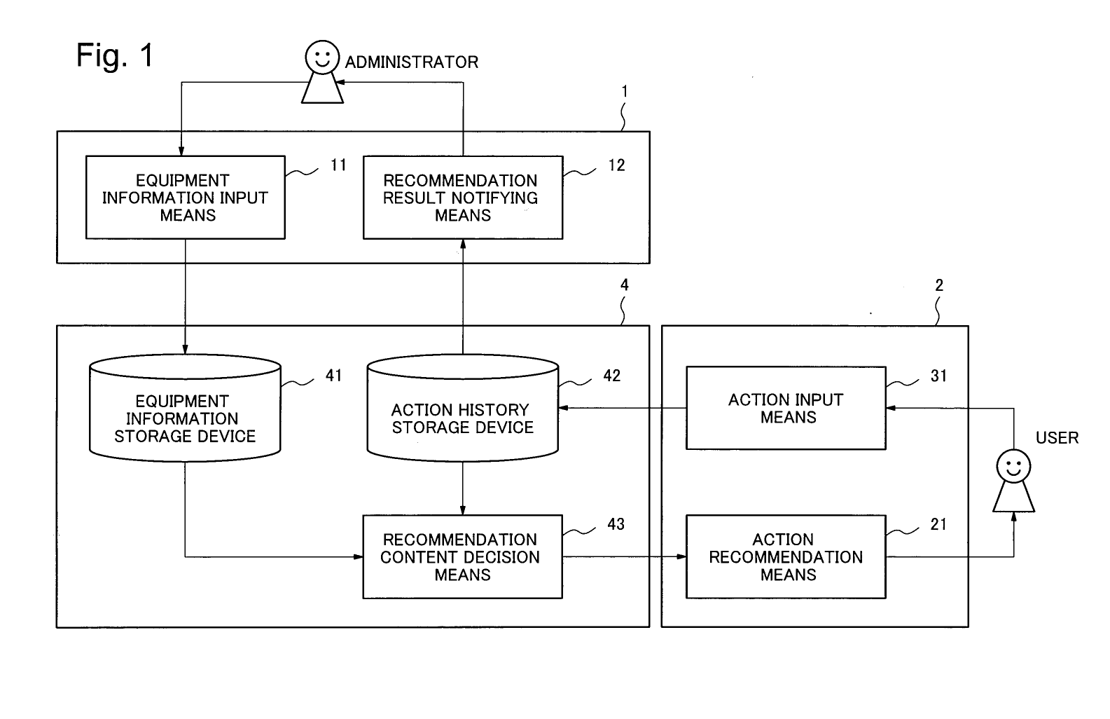

FIG. 1 is a block diagram illustrating a configuration of an energy management system of the first embodiment of the invention,

Referring to FIG. 1, the energy management system in the first embodiment of the invention includes a management terminal device 1, a user terminal device 2, and a server device 4. The energy management system in the embodiment of the invention only has to include at least the server device 4 and may configure the management terminal device 1 or the user terminal device 2, as an external device.

The management terminal device 1 includes an equipment information input means 11 and a recommendation result notification means 12. The user terminal device 2 includes an action recommendation means 21 and an action input means 31. The server device 4 includes an equipment information storage device 41, an action history storage device 42 and a recommendation content decision means 43. In the embodiment of the invention, each terminal device is connected to the server device in a communicable manner through network environment, like a general-purpose network line such as Internet, a dedicated communication network line, or a LAN (Local Area Network).

A Connection means for each terminal device and the server device is not limited to ones described above. In the saving energy described in the embodiment of the invention, various resources including electricity, gas, tap water, etc. which are necessary for operations for a facility are saving targets.

The equipment in the embodiment of the invention is a general term for ones consuming energy in a facility, like equipment for a hall where an event is held, air conditioning equipment, lodging equipment like a hotel room which a user stays, tap water equipment, or gas equipment. The equipment above described includes apparatus, or the like, which is mounted on the equipment.

### (Management Terminal Device)

The management terminal device 1 is a device to which an administrator inputs information on electric power consumption of equipment in a facility and capacity thereof, and by which a user informs the administrator of recommendation acceptance/refusal information including information on whether or not a user accepts a recommended action. As the management terminal device 1, for example, a general-purpose computer or an input device having a touch panel can be used. The management terminal device 1 may be a mobile phone terminal or a smart phone which an administrator can browse while moving. Examples described above do not limit the invention.

The equipment information input means 11 is an input means for inputting information on equipment. An administrator can input the information on equipment therein using a keyboard or a touch panel mounted on a computer. When equipment of a facility is automatically managed, a device for inputting the information on equipment is not necessarily required. Examples described above do not limit the invention.

The information inputted in the equipment information input means 11 is stored in the equipment information storage device 41.

The recommendation result notification means 12 is a means for notifying the administrator of the recommendation acceptance/refusal information of a user which is transmitted from the action history storage device 42. The recommendation acceptance/refusal information can be displayed on a display unit of a general-purpose computer, a mobile phone terminal, or the like. The recommendation result notification means 12 is not limited to ones described above.

### (User Terminal Device)

The user terminal device 2 is a device which displays a content recommended by an administrator and informs a user of it, into which an action which a user intends to act is inputted, and into which the recommendation acceptance/refusal information on whether or not a user accepts recommendation content is inputted. As the user terminal device 2, for example, a general-purpose computer or an input device with a touch panel can be used. The user terminal device 2 may be a terminal device such as a mobile phone terminal or a smart phone which an administrator can browse while moving. Examples described above do not limit the invention.

The action recommendation means 21 is a device which recommends, to a user, an action which leads to energy saving demanded by an administrator. The action recommendation means 21 can display the action to be recommended to a user on a display unit of a general-purpose computer or a mobile phone terminal. The action recommendation means 21 may display the action to be recommended to a user on a display unit which is arranged in shared equipment in a facility or may display on a dedicated terminal to be used in a facility. The action recommendation means 21 may display the action to be recommended to a user on a terminal device such as a mobile terminal or a smart phone which a user individually carries. A notifying means using the recommendation result notification means 12 is not limited to ones described above.

The action input means 31 is a means for inputting action history information of a user including equipment utilization information on a user and location information of a user, and the recommendation acceptance/refusal information of a user. The equipment utilization information and the location information do not necessarily require inputting by a user, and may be automatically acquired by another information acquiring means. The recommendation acceptance/refusal information is generated when a user selects whether to accept the recommendation content informed by the action recommendation means 21. The recommendation acceptance/refusal information is transmitted to the recommendation result notification means 12 through the action history storage device 42.

The user terminal device 2 can mount the action recommendation means 21 as a mobile phone application of a user, and the action input means 31 as a GPS (Global Positioning System) sensor of a mobile phone, on a terminal.

The action recommendation means 21 and the action input means 31 may be configured as a separate terminal. In this case, the action recommendation means 21 may be configured as a shared display monitor in a facility or as a portable information terminal which a user carries on an individual basis. The above described examples do not limit the invention.

There are various methods to configure the action input means 31. For example, a user may manually input using the action input means 31 such as a keyboard or a touch panel. It is possible to give an ID (Identification) card to a user in a theme park, check by using a reader at an entrance of a facility every time the user enters the facility of the theme park, and store data inputted from the reader. In this case, the reader may use a reading method using a card reader or a RF (Radio Frequency) tag. The action input means 31 may collect the location information of a GPS of a mobile phone. The reading method using the action input method 31 is not limited to the above examples.

### (Server Device)

The server device 4 produces the recommendation contents to a user by adjusting the equipment information accumulated in the equipment information storage device 41 and the action history information accumulated in the action history storage device 42 by the recommendation content decision means 43. As the server device 4, a general-purpose server device or a computer is available. The server device 4 is not limited to the above examples.

The energy management system of the invention only has to include at least a configuration of the server device 4.

The equipment information storage device 41 is a device for storing equipment information inputted from the equipment information input means 11. The equipment information stored in the equipment information storage device 41 is information on energy which is required when various equipment included in the facility is used, and on capacity of the equipment. The equipment information stored in the equipment information storage device 41 may include the other information. The equipment information stored in the equipment information storage device 41 may be information inputted from an input means different from the equipment information input means 11 through a communication network (not shown).

The action history storage device 42 is a device for storing action history information inputted from the action input means 31. The action history information stored in the action history storage device 42 is information on action history of a user in the facility. Information on utilization record on what equipment in the facility and how long a user uses and location information on from where and to where a user moves are included in more detail, and the pieces of the information are inputted through the action input means 31. The data stored in the action history storage device 42 includes the recommendation acceptance/refusal information on whether or not a user intends to carry out a recommended action and/or on whether or not a user actually carries out. The recommendation acceptance/refusal information is transmitted to the recommendation result notification means 12 and an administrator is informed of the information.

### (Recommendation Content Decision Means)

The recommendation content decision means 43 is a means for deciding on an action to be recommended to a user on the basis of equipment information stored in the equipment information storage device 41 and action history information stored in the action history storage device 42.

In the recommendation content decision means 43, the number of users which visit a facility a certain day is calculated on the basis of equipment information stored in the equipment information storage device 41 and action history information stored in the action history storage device 42. In the calculation, in order to recommend an action to a user on one day afternoon, the number of users whose logs of entry in the facility in the morning of the day remain may be directly used. In order to recommend an action of a next day user, the number of users which is same as the number of yesterday users may be used. The average value of the number of visitors on the same day of the week of other weeks may be used.

When information inputted by an administrator is used in order to calculate the number of users, by using the equipment information inputted from the equipment information storage device 41, calculation only has to be carried out by an energy saving condition calculation means 431 described below. When information of an equipment utilization information storage device 433 described below is used, calculation only has to be carried out by an action decision means 436.

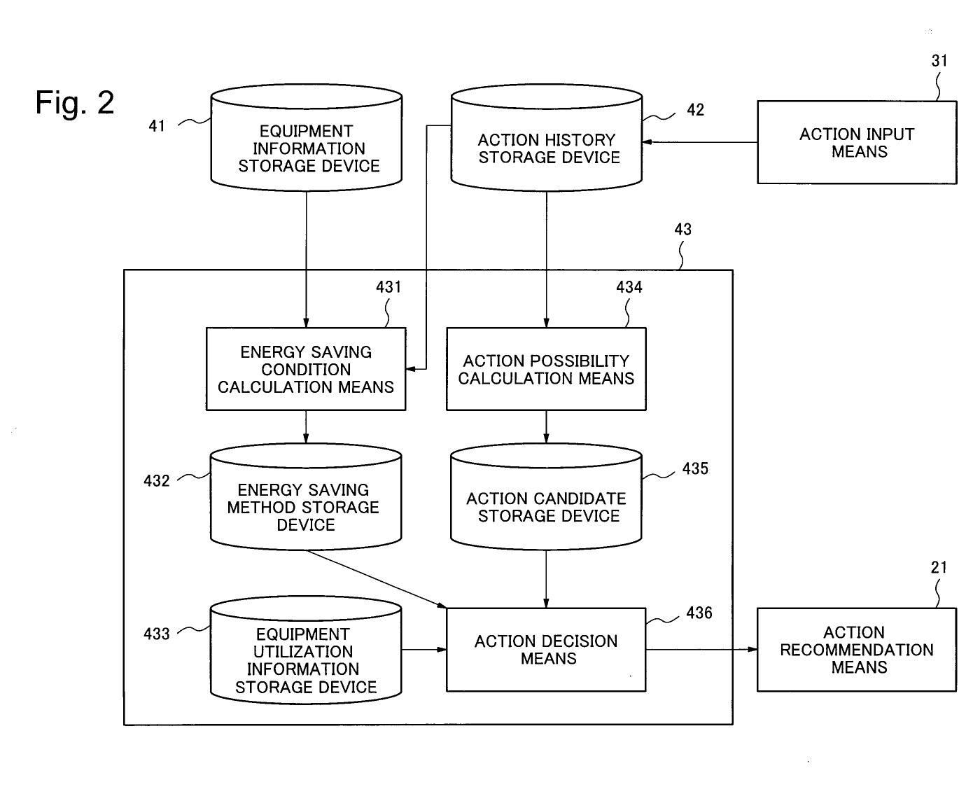

The detailed configuration of the recommendation content decision means 43 is illustrated in FIG. 2.

The recommendation content decision means 43 illustrated in FIG. 2 includes the energy saving condition calculation means 431, an energy saving method storage device 432, the equipment utilization information storage device 433, an action possibility calculation means 434, an action candidate storage device 435, and the action decision means 436. These means and devices are connected to each other in a communicable manner as shown in FIG. 2. A connection configuration which is not illustrated in FIG. 2 is possible as necessary. In FIG. 2, the energy saving condition calculation means 431 is described as the ene-saving condition calculation means 431, and the energy saving method storage device is described as the ene-saving method storage device 432.

The energy saving condition calculation means 431 calculates an ideal condition in which a facility achieves energy saving when a user uses the facility, depending on the number of users of the day. The result calculated by the energy saving condition calculation means 431 is stored in the energy saving method storage device 432. Information on an operation of the facility which reflects an administrator's demand is therefore calculated by the energy saving condition calculation means 431.

The energy saving method storage device 432 stores the result calculated by the energy saving condition calculation means 431. When the action decision means 436 calculates recommendation content, the energy saving method storage device 432 transmits the stored information on the facility operation to the action decision means 436.

The equipment utilization information storage device 433 stores information indicating a relation between what a user carries out and how the user uses equipment of the facility. A history of actions of the user and utilization situations by the user is stored in the equipment utilization information storage device 433. The equipment utilization information storage device 433 accumulates information connecting an action which a user can carry out and equipment in which the action is carried out. As information of the equipment utilization information storage device 433, a past equipment utilization situation of a user in information stored in the equipment information storage device 41 and the action history storage device 42 only has to be selected and inputted. Information on the past equipment utilization history of a user which is stored in another server may be inputted through a communication network (not shown).

The action possibility calculation means 434 calculates a candidate of an action which a user carries out with high probability from past user's action history information which is inputted through the action input means 31 and stored in the action history storage device 42. The result calculated by the action possibility calculation means 434 is transmitted to the action candidate storage device 435. The action possibility calculation means 434 calculates an action which reflects a user's demand.

The action candidate storage device 435 stores information on the action candidate which is the result calculated by the action possibility calculation means 434. When the action decision means 436 calculates the recommendation content, the stored information on the action candidate is transmitted to the action decision means 436.

The action decision means 436 carries out calculation to unite both common parts between the information on the facility operation stored the energy saving method storage device 432 and the information on the action candidate stored in the action candidate storage device 435, by using information stored in the equipment utilization information storage device 433. The result of calculation by the action decision means 436 is given to a user by using the action recommendation means 21. If the result of calculation by the action decision means 436 is not directly transmitted to the action recommendation means 21, a storage device (not shown) may store it. The calculation method of the action decision means 436 may be a method which can coordinate demands of an administrator and a user, and is not necessarily limited.

If both demands of the administrator and the user are not accorded and the common parts are not found in spite of the calculation by the action decision means 436, recalculation is carried out by the energy saving condition calculation means 431 and the action possibility calculation means 434. When the recalculation is carried out, conditions or restrictions of the recalculation are eased. To ease conditions or restrictions means to increase the number of candidates of the results derived by the energy saving condition calculation means 431 and the action possibility calculation means 434.

### (Action)

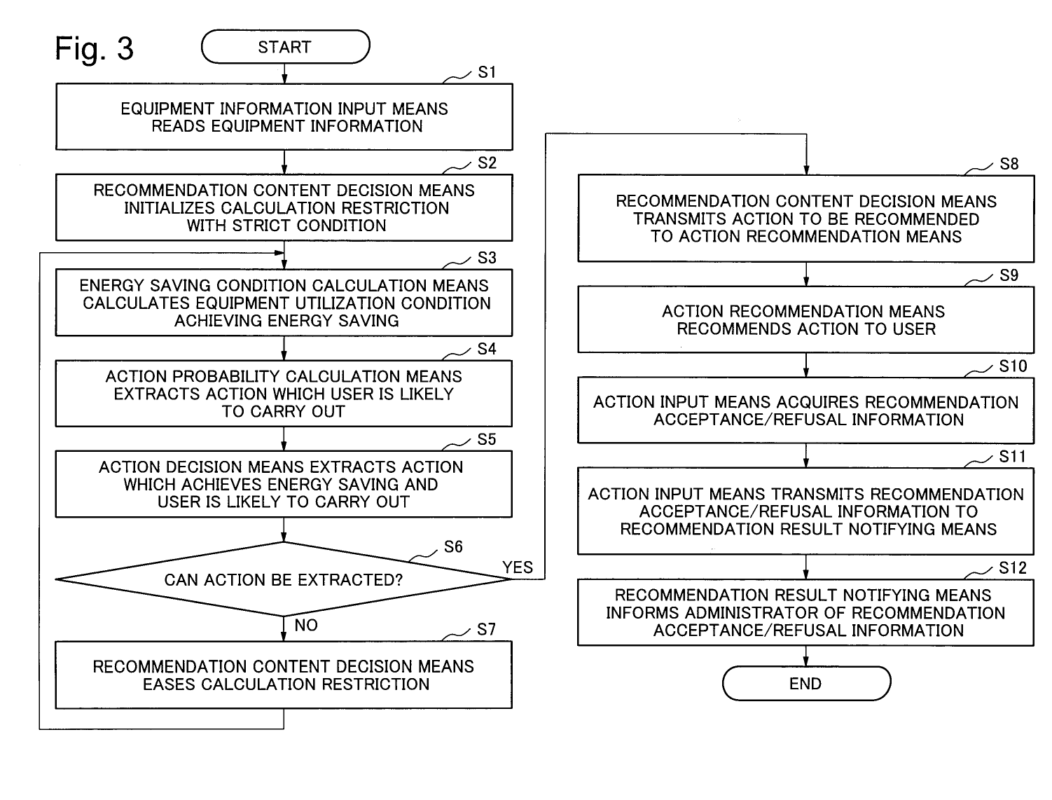

The entire operations of the embodiment are described in detail by referring to the flowchart in FIG. 3.

In FIG. 3, the equipment information input means 11 reads the equipment information inputted by an administrator (step S1).

The recommendation content decision means 43 initializes the restrictions which are given when calculation is carried out by the energy saving condition calculation means 431 or the action decision means 436 to set strict conditions (step S2). To set strict conditions means to limit the number of candidates to be outputted as the calculation results, and, for example, a threshold value, like three, is set as a default value. It is the threshold value which does not increase a calculation amount of combination when various facilities and various actions are calculated.

The energy saving condition calculation means 431 calculates an equipment utilization condition which leads to energy saving (step S3). The result of calculation by the energy saving condition calculation means 431 is stored in the energy saving method storage device 432 as the information on the facility operation.

The action possibility calculation means 434 extracts an action candidate which a user is likely to carry out (step S4). The result of calculation by the action possibility calculation means 434 is stored in the action candidate storage device 435. Step S3 and step S4 may progress in parallel.

The action decision means 436 extracts an action which leads to energy saving and which a user is likely to carry out in consideration of the calculation result of step S3 and step S4 (step S5).

If calculation restriction is strict and the action above mentioned cannot be extracted (No in step S6), the recommendation content decision means 43 eases the calculation restriction (step S7). For example, to ease the calculation restriction is to reset the threshold value into a value of four or more when a threshold value of three, as a default value. After the recommendation content decision means 43 eases the calculation restriction, recalculation is carried out in step S3.

If the action can be extracted (Yes in step S6), the recommendation content decision means 43 transmits the recommended action content to the action recommendation means 21 (step S8).

The action recommendation means 21 informs a user of the recommended action content transmitted from the recommendation content decision means 43 and recommends the action to a user (step S9).

The action input means 31 acquires a response on whether or not a user accepts the recommendation shown in the action recommendation means 21, as recommendation acceptance/refusal information (step S10).

The action input means 31 transmits the recommendation acceptance/refusal information to the recommendation result notification means 12 through the action history storage device 42 (step S11).

The recommendation result notification means 12 notifies an administrator of the user's recommendation acceptance/refusal information (step S12).

The description above is one example of the operation of the energy management system of the first embodiment. The operation of the energy management system of the first embodiment is not limited to order of the flowchart of FIG. 3, and processing order of each device may be exchanged depending on situations.

As mentioned above, according to the energy management system related to the first embodiment of the invention, both demands, “user's action which leads to maximum energy saving” which is an administrator's demand and “the most feasible action” which leads to the user's demand can be coordinated. By introducing a system seeking a point of compromise, energy saving of a facility can be achieved.

By recommending a specific action to the user, an administrator can increase probability that the specific action which leads to energy saving is carried out. Since a user does not recognize that setting of equipment which the user uses is changeable, the user carries out the recommended action, as the action which the user desires, without mandatory energy saving or without being aware of energy saving. Therefore, carrying out energy saving in accordance with the administrator's demand, the user does not have a poor image on the facility.

Recommending an appropriate action for each user, the energy management system of the embodiment of the invention may give an impression of enjoying detailed service to a user. Consequently, the user continuously uses the facility, and an advantageous effect except energy saving is therefore given to the administrator.

### Second Embodiment

A second embodiment for carrying out the invention is explained in detail by referring to drawings. The explanation of the following embodiment is an example of the invention and does not limit the invention.

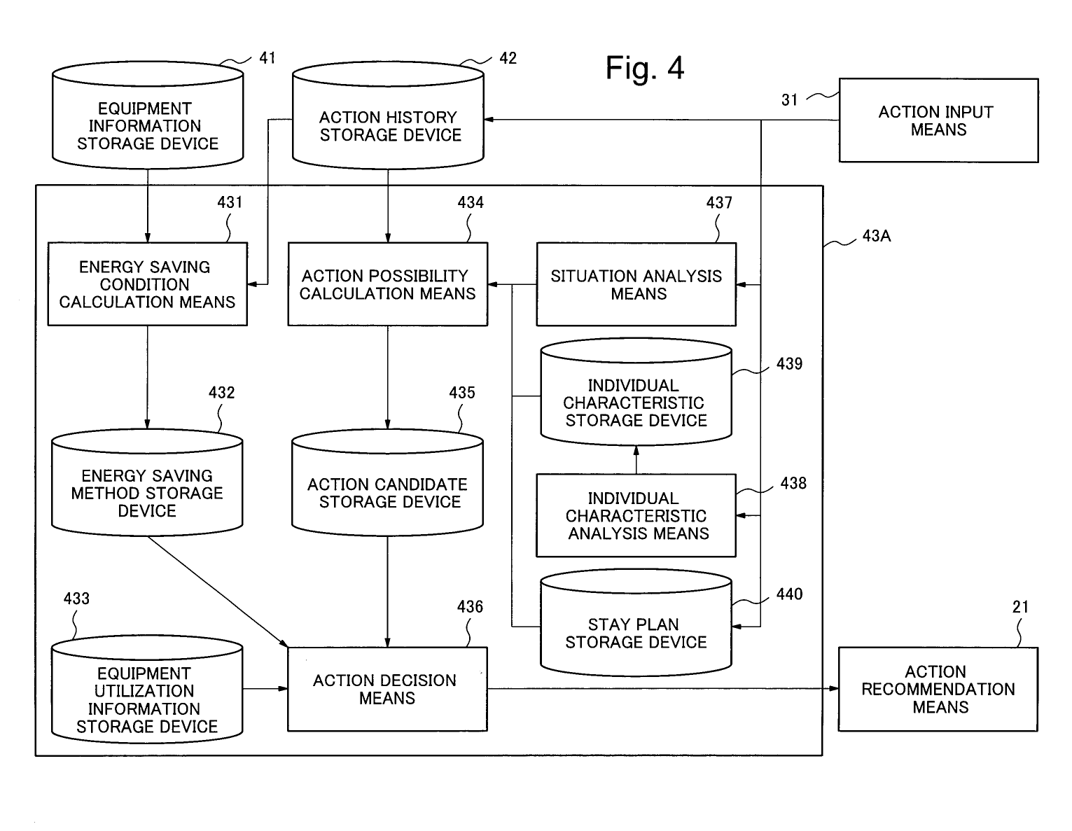

FIG. 4 is a diagram of a configuration of energy management system in a second embodiment. Referring to FIG. 4, a recommendation content decision means 43A of the energy management system in the second embodiment includes a situation analysis means 437, an individual characteristic analysis means 438, an individual characteristic storage device 439, and a stay plan storage device 440, in addition to the recommendation content decision means 43 of the first embodiment. The other configurations are similar to those of the first embodiment.

The situation analysis means 437 analyzes a situation in which feasibility on a place where a user has not yet visited or equipment which a user has not yet used is increased, on the basis of location information on a user in a facility inputted from the action input means 31 or information on a place where a user has visited in the facility. The result of analysis by the situation analysis means 437 is reflected in calculation in the action possibility calculation means 434. The result of calculation by the situation analysis means 437 may not be directly transmitted to the action possibility calculation means 434 and may be stored in a storage device (not shown). Though the management terminal device 1 and the user terminal device 2 are omitted in FIG. 4, connection situation between these devices and the recommendation content decision means 43A are similar to that of the first embodiment.

The individual characteristic analysis means 438 analyzes what a user has an interest in on the basis of information such as an individual interest inputted from the action input means 31 and information on past stay in the facility, and stores the analysis result in the individual characteristic storage device 439. As an analysis method of an individual characteristic, if data which reflects an individual taste of a user on actions outside the facility, such as POS (Point of sale) data on shopping, is available, the information may be used. The method which is used for analysis of individual characteristic information may be not only POS data but information reflecting a user's individual characteristic.

When analyzing a user's taste using the information on past stay in the facility, the individual characteristic analysis means 438 may use, for example, a usage frequency of equipment which is previously used in the facility or the past recommendation acceptance/refusal information. In this case, a value calculated in past times by dividing the number of times of a specific action which are carried out in accordance with a recommendation content by a usage frequency of all equipment including the other equipment may be an index indicating probability that the recommendation content is accepted and the specific action is carried out.

If the probability that the specific action is carried out is used for the analysis, probability that a user accepts the recommendation is increased when an action desired to be carried out is recommended to the user. If the number of times a specific action is carried out in accordance with recommendation content in past times is compared with the number of times the action is carried out without any recommendation in past times, whether or not a user carries out the action is easily determined. The analysis methods mentioned above are examples and do not limit the embodiment of the invention.

The stay plan storage device 440 stores information on a stay plan of, for example, from when to when a user stays in a theme park or when a user uses a restaurant of a hotel.

The action possibility calculation means 434 finds the common part between information stored the energy saving method storage device 432 and information stored in the action candidate storage device 435 by calculation. In the second embodiment, in the calculation by the action possibility calculation means 434, the analysis result by the situation analysis means 437 and information stored in the individual characteristic storage device 439 and the stay plan storage device 440 are used. According to the second embodiment, since information on a user is added when an action which a user probably carries out is calculated by the action possibility calculation means 434, highly feasible actions which meet a situation can be extracted. Compared with the first embodiment, probability that an action recommended to a user is carried out can be increased.

### Third Embodiment

A third embodiment for carrying out the invention is explained in detail by referring to drawings. The explanation of the following embodiment is an example of the invention and does not limit the invention.

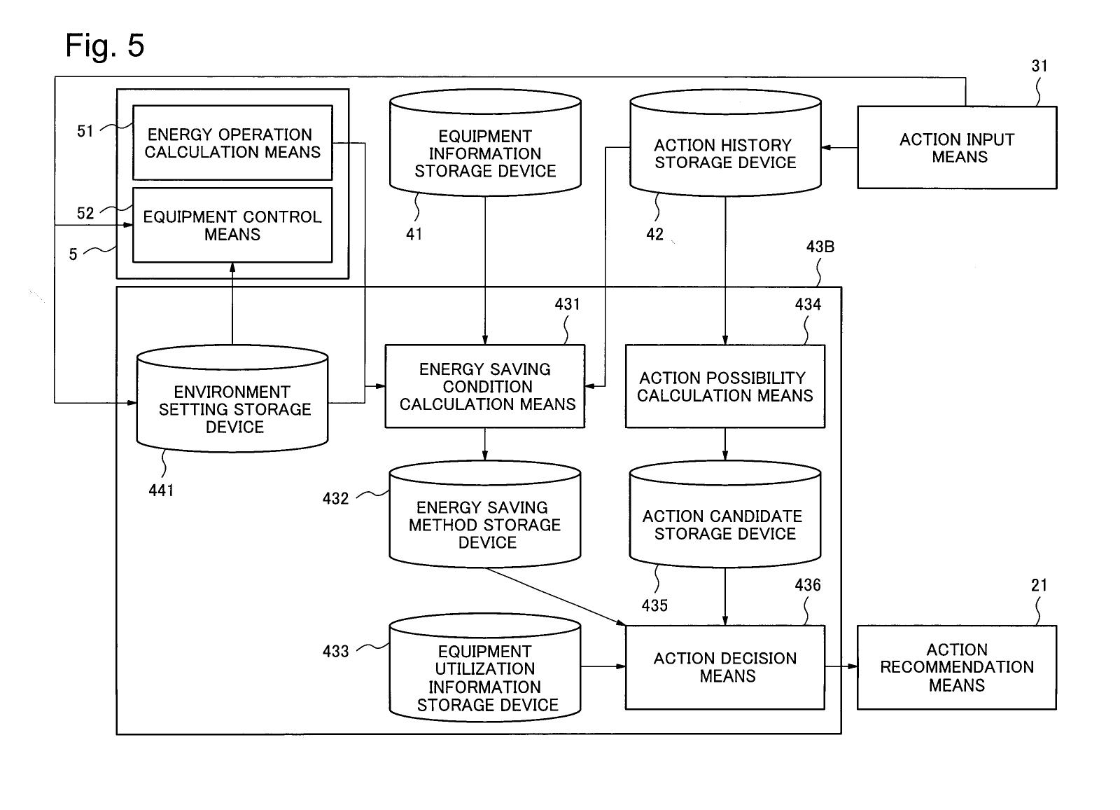

FIG. 5 is a diagram of a configuration of an energy management system of the third embodiment. Referring to FIG. 5, the energy management system of the third embodiment differs from the first embodiment in the following.

A recommendation content decision means 43B of the third embodiment includes an environment setting storage device 441 in addition to the recommendation content decision means 43 of the first embodiment. The energy management system of the third embodiment includes a control terminal device 5 with an energy operation calculation means 51 and an equipment control means 52. The above is difference between the third embodiment and the first embodiment. Though the management terminal device 1 and the user terminal device 2 are omitted in FIG. 5, a connection situation between these devices and the recommendation content decision means 43B is similar to that of the first embodiment.

In the environment setting storage device 441, environment setting which is temperature, humidity, and brightness of illumination which are set when a user uses a facility is stored. The environment setting is probably environment setting which a user desires. If the environment setting is automatically reproduced by the equipment control means 52, probability that a user separately changes the environment setting is reduced and the whole facility is streamlined. It is possible to give, to a user, impression of enjoying comfortable and quality service. As information of the environment setting storage device 441, in information stored the equipment information storage device 41 or the action history storage device 42, a past utilization situation of a user only has to be selected and read, or relevant information which is stored in another server device only has to be inputted through a communication network (not shown).

The control terminal device 5 controls equipment in the facility, without input by an administrator, on the basis of information acquired from the action input means 31 and the environment setting storage device 441. An equipment operating condition by which the highest energy efficiency is acquired is calculated and the calculation result is transmitted to the energy saving condition calculation means 431.

Specifically the energy operation calculation means 51 calculates an operating method with the highest efficiency in the whole equipment of the facility and the calculation result is reflected in the energy saving condition calculation means 431. Having no connection in which information is inputted, the energy operation calculation means 51 may include in advance a storage device storing an optimum management condition. The energy operation calculation means 51 may be connected to the equipment utilization information storage device 433 or the equipment information storage device 41 in a communicable manner (not shown).

The equipment control means 52 automatically carries out operation-pause of equipment, setting of air conditioning, or the like, in accordance with the determined user's action, and enables more efficient energy saving compared with manual management of an equipment condition which is carried out by an administrator. The equipment control means 52 is connected to each piece of equipment in the facility through a communication network in a communicable manner, and can control a driving condition of each piece of equipment.

According to the energy management system of the third embodiment, an action extracted by the recommendation content decision means 43 is reflected in energy control of the facility and energy saving control is automatically carried out in the facility in addition to the user's action. Therefore, compared with the energy management systems of the first and the second embodiments, the advantageous effect of energy saving is further increased in the energy management system of the third embodiment.

### Exemplary Embodiment 1

Next, using a specific exemplary embodiment, an operation of an embodiment of the invention is explained. An exemplary embodiment 1 corresponds to an exemplary embodiment of the first embodiment.

In a following exemplary embodiment, a theme park having a plurality of attraction facilities and a hotel is exemplified. In the following embodiment, an operation example of a case, in which time spent in a room of the hotel is reduced in the theme park by getting visiting users to use a large attraction and to join an event and energy saving is achieved in a whole of the theme park, is described.

Initially, as restriction of calculation, a threshold value of calculation by the energy saving condition calculation means 431 and the threshold value of the action decision means 436 are set (corresponding to step S2 in flowchart of FIG. 3). The threshold values of the energy saving condition calculation means 431 and the action decision means 436 are values indicating what number candidate is calculated when a utilization condition of equipment in which the facility achieves energy saving is calculated.

Initially, a step of extracting an action which reflects a demand of the theme park administrator is explained.

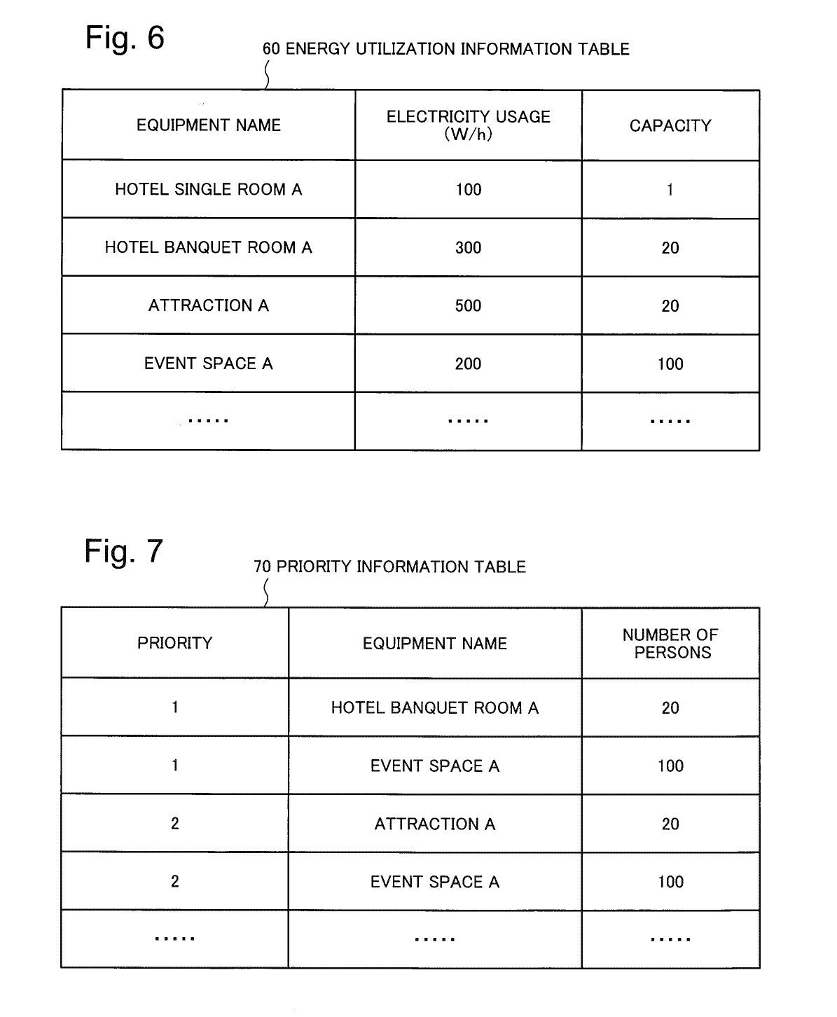

The administrator generates an energy usage information table 60 in which energy usage information on equipment shown in FIG. 6 is inputted by the equipment information input means 11. The equipment information storage device 41 stores the energy usage information table 60. Though FIG. 6 shows four pieces of equipment, four or more than four pieces of equipment, or three or less pieces of equipment may be arranged. In the calculation below, only a part of results is described as an example.

The energy usage information on equipment is, for example, a usage amount of electricity which is used while a guest stays in a hotel room, a usage amount of electricity which is required for operating one attraction, or the like. Not only the usage amount of electricity, but also amounts of water and gas which are used in a hot spring facility and an amount of gasoline which is used by bus running around in the theme park may be included. The energy usage information, which is information on energy used in the facility, is not limited to the above mentioned.

Through an electricity usage amount of a hotel single room A, as the same type of room, is illustrated in FIG. 6, a different lodging situation is acceptable. A case in which one guest stays in a twin room, a case in which a married couple stays therein, or a case in which guests including a child stay therein is supposed. A case in which two women stay and a case in which two men stay are also supposed. Since a detailed usage amount is different depending on these lodging situation, usage amount data for each user's property may be prepared in consideration of that. The lodging situation is not limited the above described.

The energy saving condition calculation means 431 carries out following calculation.

On the basis of the data shown in FIG. 6, electricity usage amount per one person which is used for one hour when users corresponding to capacity of equipment get gather at each of the equipment is calculated as follows.

The hotel single room A has a maximum capacity of one person, who consumes electricity of 100 W/person for one hour.

A hotel banquet room A has a maximum capacity of twenty persons, and one person consumes electricity of 15 W/person for one hour.

An attraction A has a maximum capacity of twenty persons, and one person consumes electricity of 25 W/person for one hour.

An event space A has a maximum capacity of a hundred persons, and one person consumes electricity of 2 W/person for one hour.

If the number of visitors is one hundred and twenty, the highest efficiency is achieved when the number of persons is allocated in order of the least electricity usage amount per one person. For example, following allocation can be calculated. A default value of the number of candidates to be calculated is restricted to three.

In a first candidate, the event space A accommodates one hundred persons and the hotel banquet room A accommodates twenty persons, respectively. Therefore, since the event space A consumes 200 W per one hour and the hotel banquet room A consumes 300 W per one hour, total electric power consumption becomes 500 W.

In a second candidate, the event space A accommodates one hundred persons, the hotel banquet room accommodates nineteen persons, and the attraction A accommodates one person, respectively. Since the event space A consumes 200 W per one hour, the hotel banquet room consumes 185 W per one hour, and the attraction A consumes 25 W per one hour, respectively, total electric power consumption becomes 500 W.

In a third candidate, the event space A accommodates one hundred persons, the hotel banquet room accommodates eighteen persons, and the attraction A accommodates two persons, respectively. Since the event space A consumes 200 W per one hour, the hotel banquet room consumes 180 W per one hour, and the attraction A consumes 50 W per one hour, respectively, total electric power consumption becomes 530 W.

However, minimum electric power which is required in order to operate equipment includes operation electric power having nothing to do with the number of users using the equipment. In management of a plurality of pieces of equipment, it is easy to manage fewer pieces of working equipment. It may be better to operate only one of the attraction A and the hotel banquet compared with holding the attraction A for one or two persons. In consideration of the idea, the energy saving condition calculation means 431 gives, for example, following calculation result.

In the first candidate, the event space A accommodates one hundred persons and the hotel banquet room A accommodates twenty persons, respectively. Therefore, since the event space A consumes 200 W per one hour and the hotel banquet room A consumes 300 W per one hour, total electric power consumption becomes 500 W.

In the second candidate, the event space A accommodates one hundred persons, the attraction A accommodates twenty persons, respectively. Since the event space A consumes 200 W per one hour and the attraction A consumes 500 W per one hour, respectively, total electric power consumption becomes 700 W.

In the exemplary embodiment, the third and following candidates are omitted.

When the result is stored in the energy saving method storage device 432 as data with priority order, a priority order information table 70 of FIG. 70 is provided.

In the above calculation, which equipment persons should be assembled in and how many persons should be assembled are described in the easiest way. Alternatively, one day plan, in which persons are assembled in the event space in the morning and are assembled in the attraction in the afternoon, may be made.

The calculation by the energy saving condition calculation means 431 may be carried out using a simple method in which the number of visitors who are already in the theme park or are expected to be there is allocated in order for each piece of equipment. Next utilization condition of each piece of equipment may be estimated and calculated on the basis of the past utilization information.

A step of extracting an action reflecting an administrator's demand, as the priority order information table 70 is described above.

Next a step of extracting an action reflecting a user's demand is described.

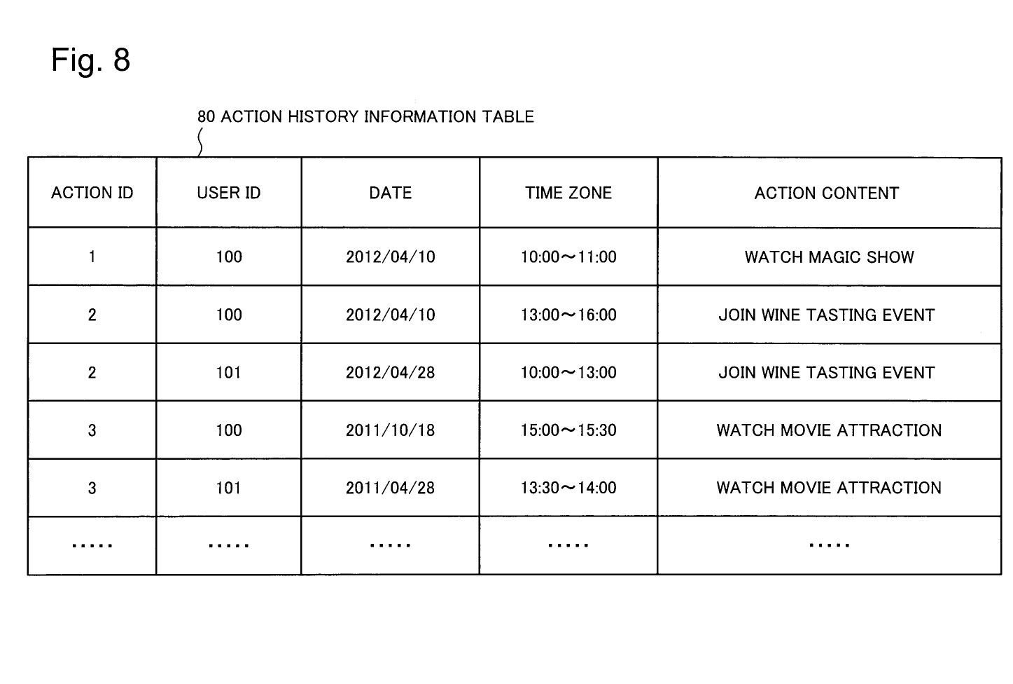

The action history storage device 42 stores an action history information table 80 showing how each user acts in the theme park, as shown in FIG. 8.

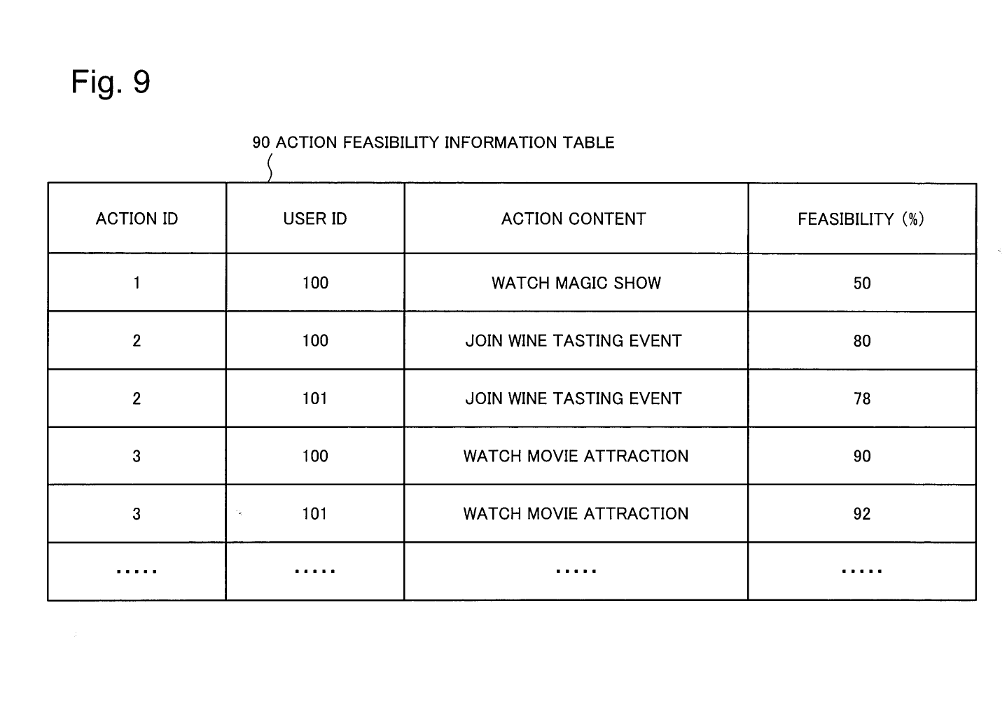

The result which the action possibility calculation means 434 calculates by using the data in the action history information table 80 is stored in the action candidate storage device 435 as an action feasibility information table 90 shown in FIG. 9.

The action feasibility information table 90 in FIG. 9 shows how much possibility that each user carries out each action exists. The calculation may be carried out by using the method which is used when a targeted user selects a commodity which is the most likely to be purchased. If probability of a user's action is increased, a calculation means by the action possibility calculation means 434 is not limited thereto.

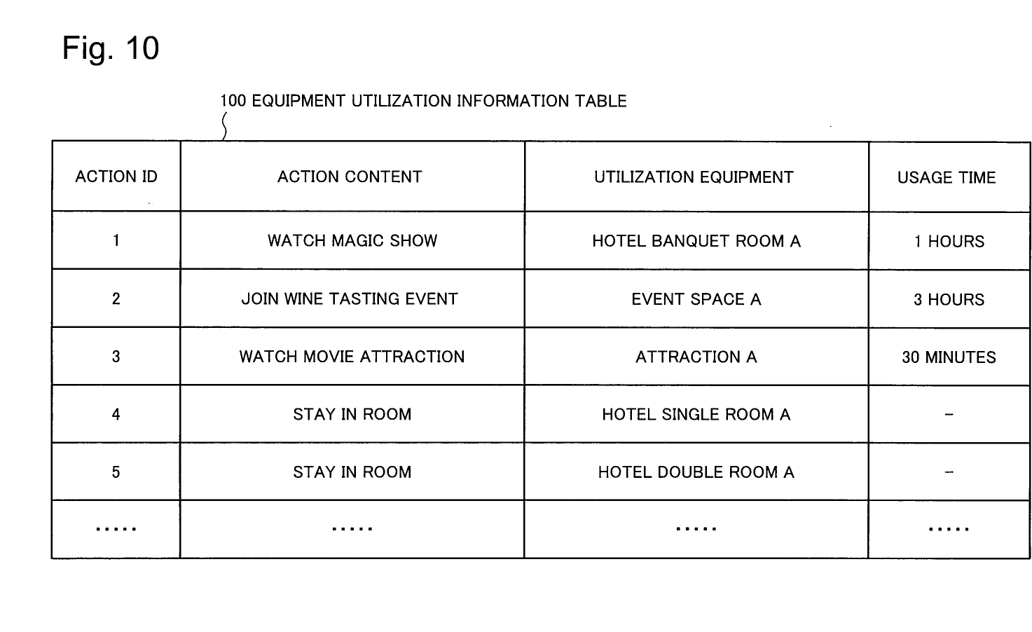

When an action content which reflects demands of both an administrator and a user is calculated, the action decision means 436 searches a common point and a compromise point between action candidates of an administrator and a user using data of an equipment utilization information table 100 of FIG. 10 which is stored in the equipment utilization information storage device 433.

The action decision means 436 collates data of the action feasibility information table 90 with data of the equipment utilization information table 100 and thus generates an equipment feasibility information table 110 which is a correspondence table of a user ID, utilization equipment and feasibility. In the case, information on a user who has not visited is not included in the equipment feasibility information table 110. An action which a user has not carried out is included in the correspondence table by estimating some possibility. The generated equipment feasibility information table 110 may be stored in a storage device (not shown) which is accessible by the action decision means 436.

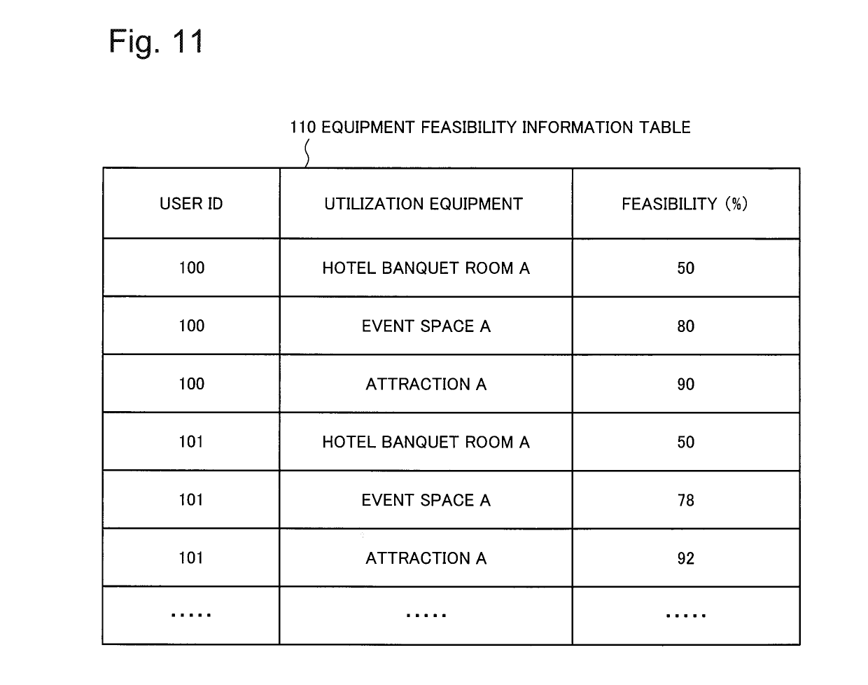

In the equipment feasibility information table 110 in FIG. 11, it is estimated that having not seen a magic show, a user 101 does not see the magic show at this time, and feasibility of utilization of the hotel banquet room A is 50%. Calculation may be carried out by using a statistic value of the whole users who have seen the magic show, by calculating using a numerical value of action possibility of a user having a similar profile, or on the basis of rate of carrying out that when the magic show is recommended to another user for the first time. These calculation methods are not limited to the above described.

According to the equipment feasibility information table 110 in FIG. 11, for example, since a user of ID No. 100 has probability of 90% of watching a movie attraction, it can be estimated that it is more likely to be guided to the attraction A. Since a user of ID No. 101 also has probability of 90% of watching the movie attraction, it can be estimated that it is more likely to be guided to the attraction A. Since the user of ID No. 100 has probability of 50% of watching the magic show, it can be estimated that it is not likely to be guided to the hotel banquet room A.

When the equipment feasibility information table 110 is sorted for each piece of utilization equipment, and an ID of a user who probably uses the equipment and action probability are extracted for each user having high action probability, following data is extracted.

Hotel banquet room A:(ID=100, 50%), (ID=101, 50%), . . . .

Event space A:(ID=100, 80%), (ID=101, 78%), . . . .

Attraction A:(ID=100, 90%), (ID=101, 92%), . . . .

Next, when combination information of equipment utilization in which energy saving is achieved, like the priority order information table 70 shown in FIG. 7, exists, the action decision means 436 calculates an evaluation value E (Cj) of equipment combination Cj. Here, the combination of equipment utilization in which energy saving is achieved is combination of pieces of equipment whose priorities accord with each other.

Put action probability of a kth user who is allocated to jth equipment included in Cj is Pj,k. Put energy usage amount, which is consumed when the user uses the equipment, is Aj,k, and put energy usage amount which the user can use without action recommendation is Bj,k. An expectation value of a maximum value of an energy usage amount which the user can save is calculated to be the following equation 1.

Pj,k×(Bj,k−Aj,k) (1)

Aj,k and Bj,k are usage amounts per one person of equipment calculated from the energy usage information table 60. Bj,k may be a usage amount of the equipment on the basis of data of a position where the user is currently located, and, if the data does not exist, may be a usage amount of the equipment having the maximum energy usage amount in equipment which the user can use in order to calculate the maximum value of an amount in which energy saving can be achieved.

The expectation value of the maximum value of the energy usage amount which the user can save, which is calculated by the equation 1, is totalized with respect to all pieces of equipment and users to be the following equation 2, which is an evaluation value of combination Ci of pieces of equipment.

E(Ci)=ΣjΣkPj,k×(Bj,k−Aj,k) (2)

E(Ci) represents an expectation value of an energy saving amount which is acquired when users are allocated to the equipment.

The action decision means 436 allocates a user so that this E(Ci) is maximized. The allocation result by the action decision means 436 may be stored in a storage device (not shown) which the action decision means 436 can access.

The allocation method of the action decision means 436 may be a method in which values of E(Ci) are compared by allocating a user to equipment using every method, and, if a calculation amount is increased due to the large number of users, the number of users for the calculation may be reduced by performing pruning. After E(Ci) is calculated through the calculation, a usage amount of energy which is consumed when the equipment is used, i.e. when an event is held is compared therewith. For example, the action decision means 436 can access the equipment information storage device 41, acquires the energy usage information table 60 of FIG. 6, and compares data in a column of electricity usage amount with the calculated E(Ci). The energy usage information table 60 may be transmitted to the energy saving method storage device 432 and stored therein.

If E(Ci) is larger than the electricity usage amounts in the energy usage information table 60 of FIG. 6, the action decision means 436 considers that the event leads a user, and determines as a recommendation content. If E(Ci) is smaller, since an effect of leading is not acquired, an action to be recommended is not extracted. If user's action probability is decreased, a probability that an action to be recommended is not extracted is increased, and thus recalculation is carried out by increasing the number of candidates of combination of pieces of equipment in the priority order information table 70 shown in FIG. 7(step S7 in flowchart of FIG. 3). For example, if the number of initial candidates is three, a numerical value which is larger than the number of initial candidates, such as four or five, is set as the number of candidates. This process is carried out until an action to be recommended is extracted. Until another combination is extracted, in which user's action probability is high to some extent and an effect of leading to the action exists, the operation of step S7 in the flowchart of FIG. 3 is repeated.

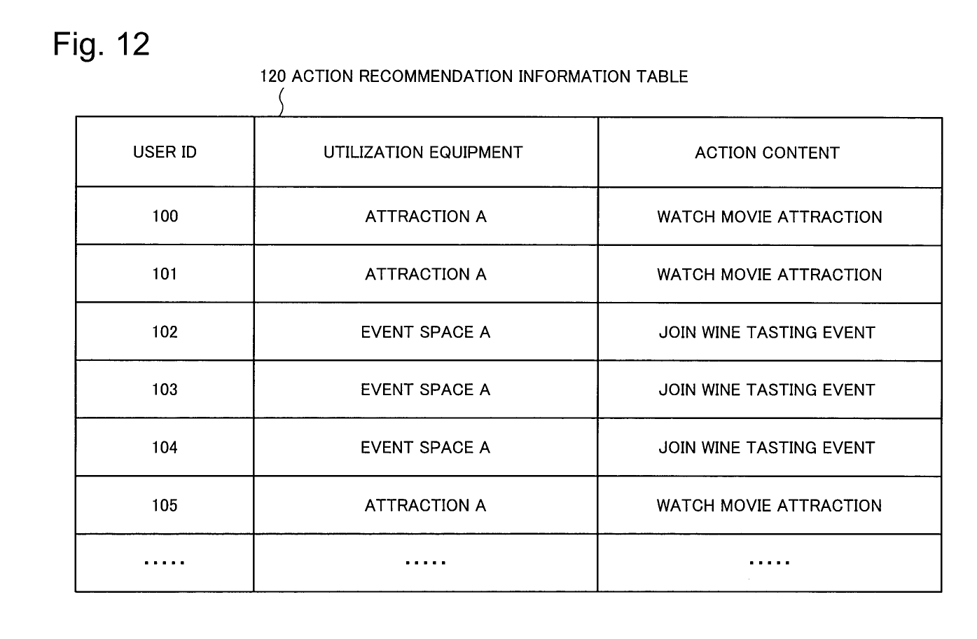

When a combination of pieces of equipment whose priority order is two in the priority order information table 70 of FIG. 7 is selected on the basis of the above calculation of the action decision means 436, what action is recommended to which user can be arranged as an action recommendation information table 120 of FIG. 12.

The action recommendation means 21 notifies each user of the content and the place for the action on the basis of the action recommendation information table 120 of FIG. 12.

For example, application software of mobile phones of users having ID 100, 101, and 105 receive a guideline sentence “Would you like to watch a movie at the attraction A?” Users having ID 102 to 105 receive a guideline sentence “A wine tasting event is held at the event space A. We′d like you to join us.”

After that, the recommendation result notification means 12 acquires the recommendation acceptance/refusal information inputted in the action input means 31 and notifies an administrator of whether or not the user carries out the recommended action.

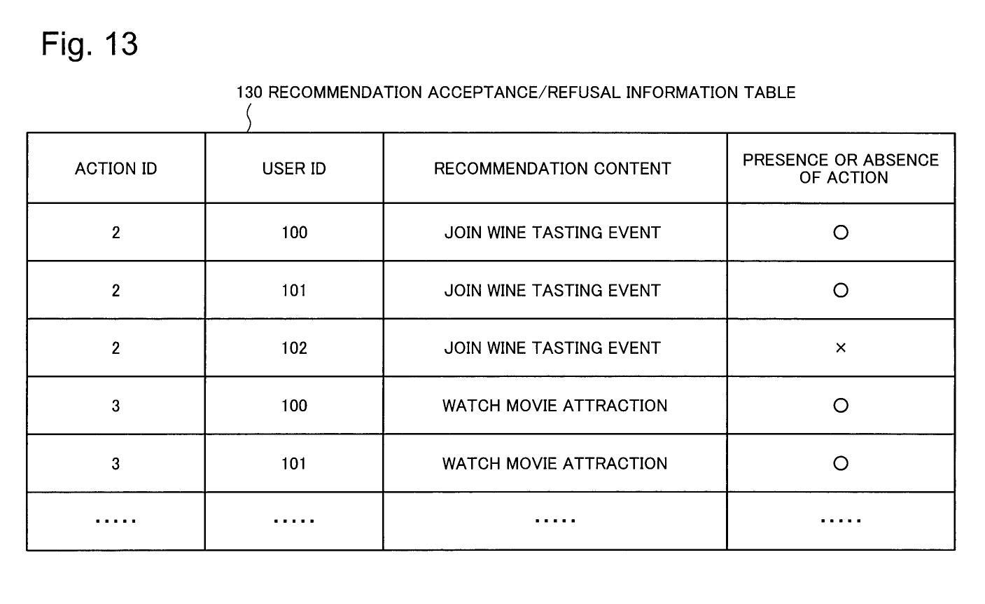

The recommendation acceptance/refusal information can be inputted into the action input means 31 by using a method in which a dedicated application software is downloaded in a user's mobile phone, a recommendation content as a recommendation plan is transmitted if it is held up at an entrance of the theme park, and a button for determining whether to join is pressed on the application software. As a result, action recommendation shown in FIG. 13 and a recommendation acceptance/refusal information table 130 which is a result thereof are stored in the action history storage device 42. A method for acquiring the recommendation acceptance/refusal information is not limited to the above method, and whether or not the user accepts the recommendation content only has to be inputted in the action input means 31.

For example, if the recommendation acceptance/refusal information is sent to the administrator and if fifteen users accept participation in the wine tasting event, the administrator prepares the wine tasting event for the fifteen users. In this case, until the wine tasting event is finished, it is possible to perform an equipment operation such as suspension of air conditioning of the rooms in which the users who join the wine tasting event are scheduled to stay, without users' awareness.

### Exemplary Embodiment 2

Examples of operations of the situation analysis means 437, the individual characteristic analysis means 438, the individual characteristic storage device 439, and the stay plan storage device 440 which are added to the recommendation content decision means 43, and the action possibility calculation means 434 in the second embodiment shown in FIG. 4 are described with respect to the second exemplary embodiment using the example of the theme park similar to that of the first exemplary embodiment. The other configurations and operations which are similar to those of the first exemplary embodiment are not described.

The individual characteristic analysis means 438 characteristics of respective users using data of the action input means 31 or the action history storage device 42. For example, suppose that the action history storage device 42 stores a user ID described in the action history information table 80, and the date, the time, and the content of the event joined in past times. Further a recommendation content, and presence or absence of performance for respective users which are shown in the recommendation acceptance/refusal information table 130 of FIG. 13 are stored.

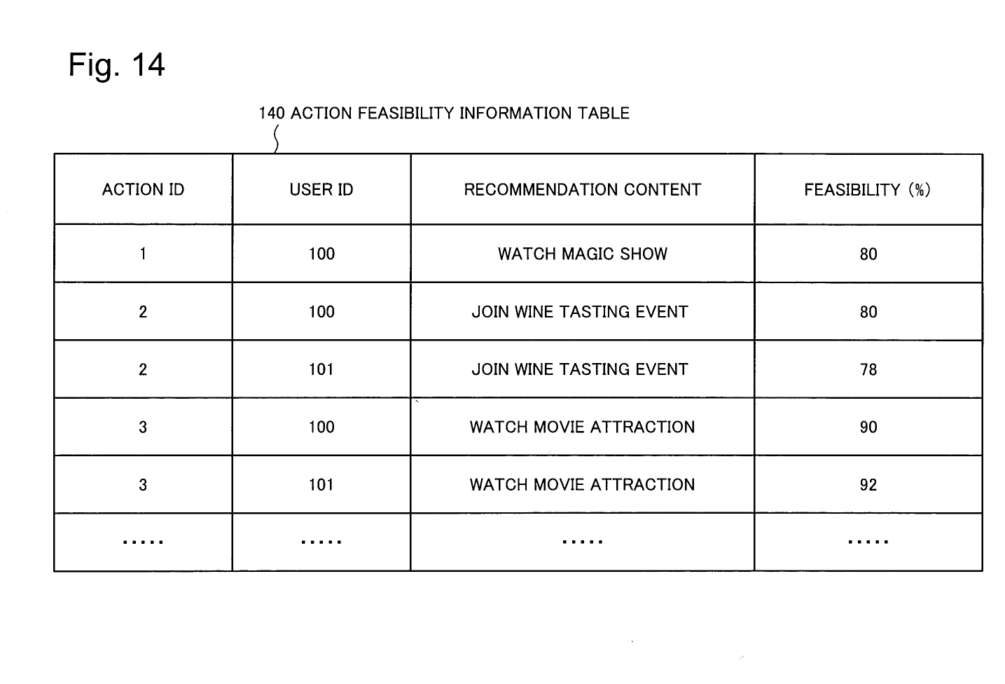

The individual characteristic analysis means 438 calculates data on a list of recommending actions and feasibility thereof which are shown in an action feasibility information table 140 in FIG. 14, on the basis of data of the action history information table 80 and the recommendation acceptance/refusal information table 130, and stores it in the individual characteristic storage device 439.

The feasibility may be calculated, like the exemplary embodiment 1, on the basis of rate of actual performance of the action which is recommended in past times, or on the basis of rate of performance of the action in all the actions which the user acted in past times.

The calculation carried out in the individual characteristic analysis means 438 is not limited to the content of the action feasibility information table 140 in FIG. 14. For example, if a system which calculates an action which is the most likely to be carried out by a user is available, an action which the user is likely to carry out, an action which a user having the profile which is similar to that of the user is likely to carry out, an action in which rate of performance is high in all users, or the like, may be calculated.

Since an action suitable for male and an action suitable for female depending on content of an action to be recommended, calculation which reflects statistical difference due to sex may be carried out. A method for calculating feasibility is not limited to the above described.

After the calculation by the individual characteristic analysis means 438, the situation analysis means 437 calculates location information on where a user is currently located and has been located until now on the basis of information on a user inputted from the action input means 31. The location information on a user may be a two-dimensional position coordinate in which the specific point in the theme park is a point of origin, and may be a three-dimensional position coordinate having height information. The location information on a user may be information on longitude and latitude which are acquired through GPS.

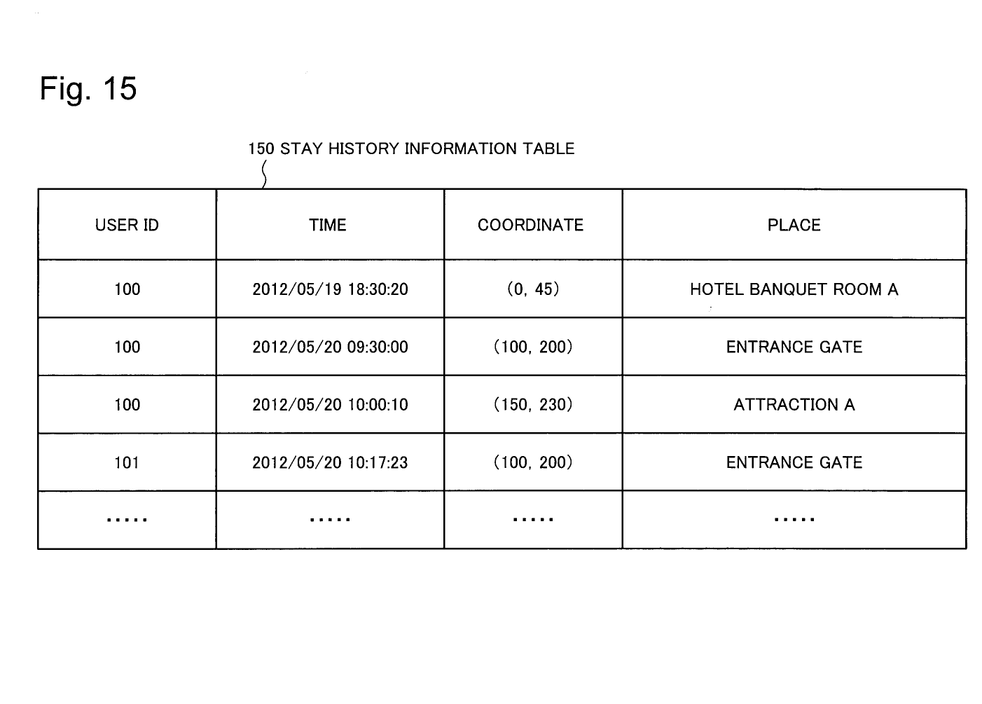

An example of the calculation result by the situation analysis means 437 is illustrated in a stay history information table 150 in FIG. 15.

The stay history information table 150 can be made by a system in which an ID card common to the theme park and the hotel is given to a user and reader devices which arranged at entrances of the theme park and the hotel and entrances of the attractions read the ID card. The ID card may be mechanical or magnetic key information which is touched on a card reader. A card reader may be a non-contact reader such as a RF tag. The ID card is not limited, if ID information included in the ID card can be read by the reader. Location information acquiring means other than the ID card reading may be used.

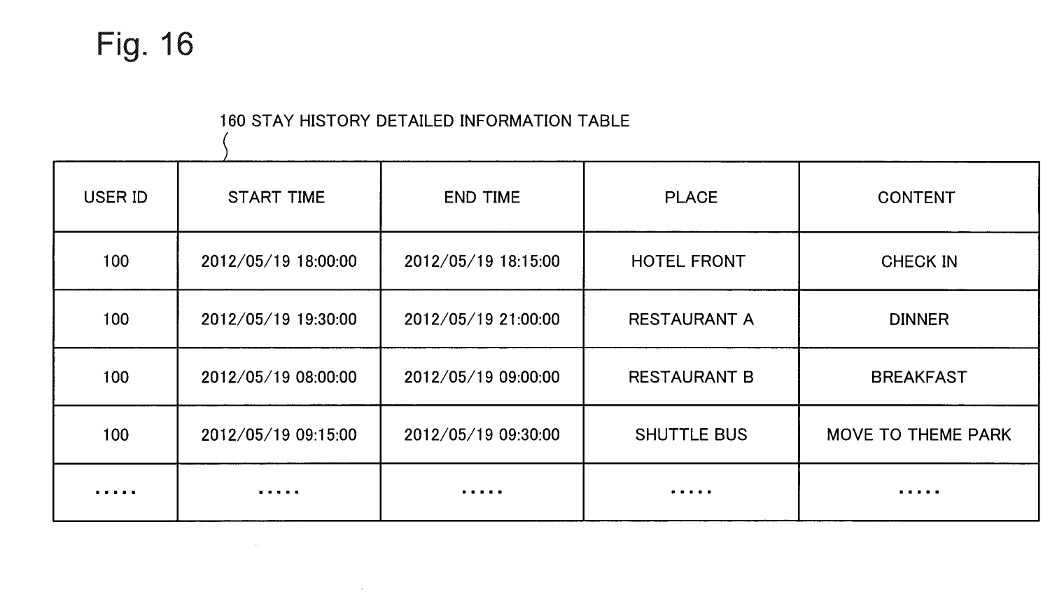

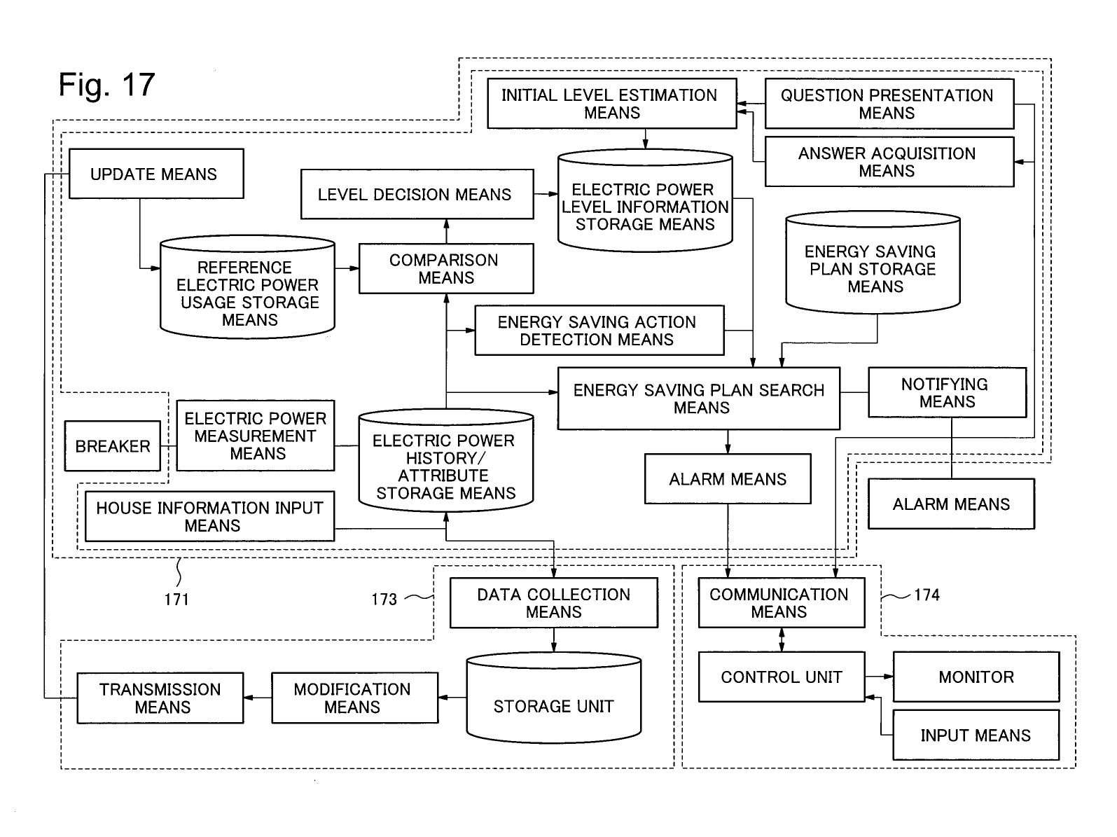

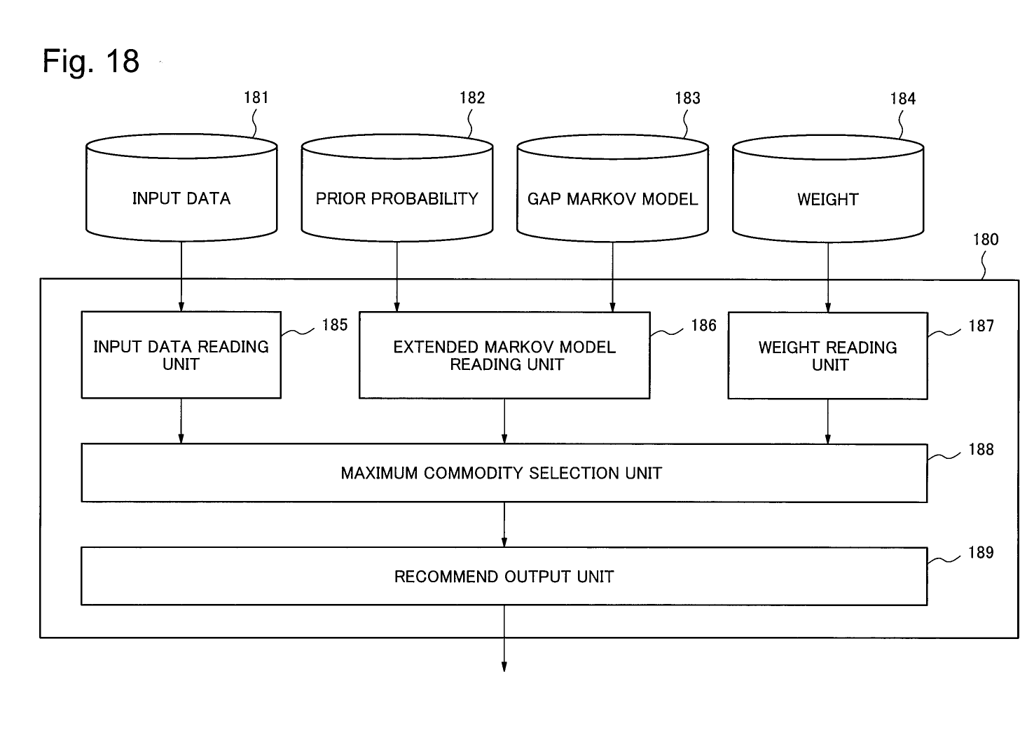

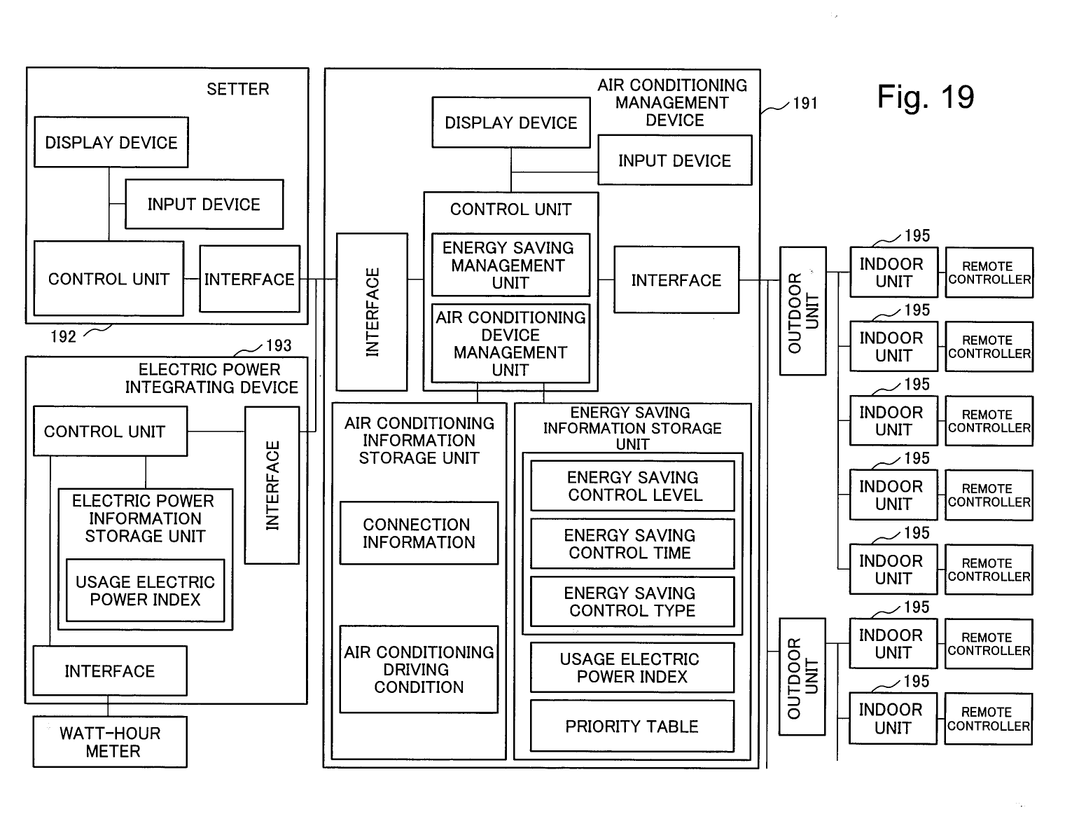

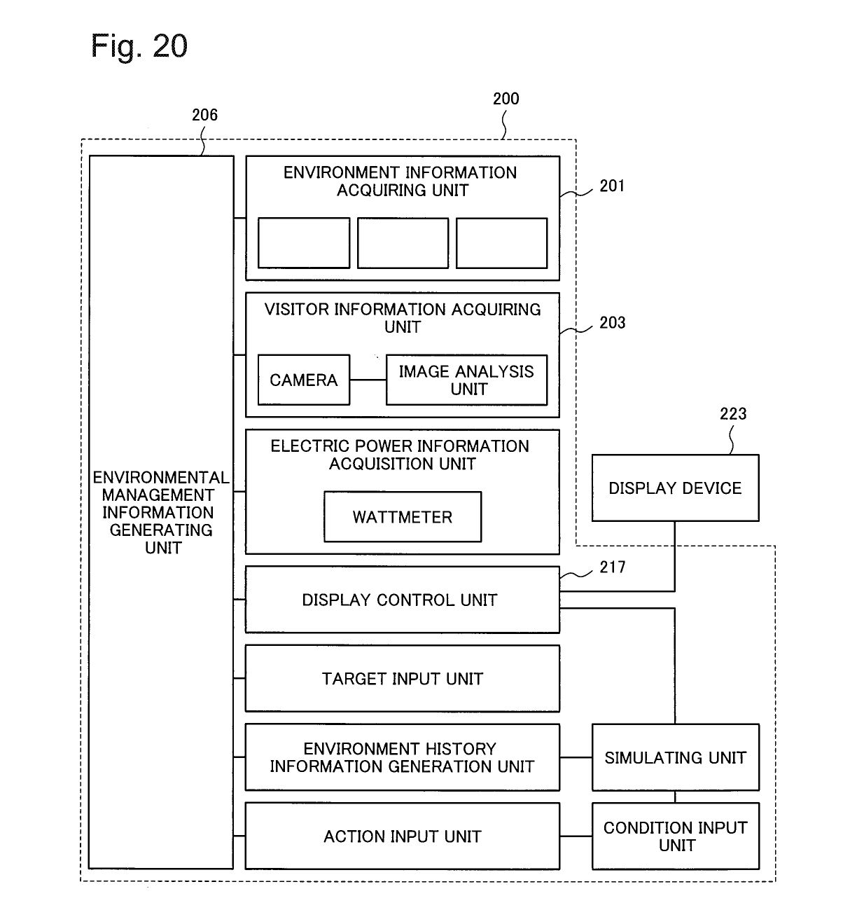

The action possibility calculation means 434 calculates an action which a user is likely to carry out and feasibility from a content of the stay history information table 150, a content of a user's action plan shown in a stay history detailed information table 160 of FIG. 16 stored in the stay plan storage device 440, and information stored in the individual characteristic storage device 439. For example, if calculation is carried out, on the morning of May 20, 2012 in order to recommend an action of the day in the theme park, the result is shown in the action feasibility information table 90 of FIG. 9.

According to the action feasibility information table 140 stored in the individual characteristic storage device 439 shown in FIG. 14, feasibility of a user's action “watch a magic show” is 80%. However, if it is turned out that the user watched the magic show last night on the basis of the analysis result by the situation analysis means 437, the feasibility becomes a value lower than that.

Through examples of the action feasibility information table 140 of FIG. 14 and the action feasibility information table 90 of FIG. 9 show the result which is not changed except “watch a magic show”, processes can be carried out, in which feasibility of an attraction carried out at a place near the user's current position is increased and recommendation is carried out in real time, or on the basis of a booking situation of a restaurant or a shuttle bus in a user's stay plan, an event which overlaps the time zone may be deleted.

### Exemplary Embodiment 3

Examples of the environment setting storage device 441, the energy operation calculation means 51, and the equipment control means 52 added to the recommendation content decision means 43 in a third embodiment shown in FIG. 3 are described as the third exemplary embodiment using the example of the theme park similar to that of the first exemplary embodiment. Since the other configurations and operations are similar to those of the first embodiment and the second embodiment, detailed descriptions on the same configurations and operations are omitted.

In the exemplary embodiment 3, suppose that a user can set environment setting such as an air conditioner and an air conditioning arranged in a hotel room or a temperature of hot water in a bath by oneself. The action input means 31 acquires environment setting set by a user. The environment setting acquired by the action input means 31 is stored in the environment setting storage device 441.

The energy operation calculation means 51 calculates optimum energy distribution which is acquired when it is supposed that a user acts as instructed in the hotel and the theme park, and reflects it in calculation of the energy saving condition calculation means 431.

The energy saving condition calculation means 431 calculates an ideal situation in which energy saving is achieved in the facility on the basis of data acquired from the equipment information storage device 41, the action history storage device 42, the environment setting storage device 441, and the energy operation calculation means 51. Being similar to the exemplary embodiment 1 or the exemplary embodiment 2, the other operation flows are omitted.

According to the third exemplary embodiment 3, when the action decision means 436 calculates an action of each user and an energy saving effect thereof, calculation can be carried out using a more practical value since an energy operation condition of the facility is considered. The result calculated by the action decision means 436 is recommended to a user by the action recommendation means 21, and the user inputs whether to carry out the calculation result as recommendation acceptance/refusal information using the action input means 31. The equipment control means 52 controls energy utilization for each piece of equipment in accordance with the recommendation acceptance/refusal information of the user.

For example, suppose that “join wine tasting event” shown in the recommendation acceptance/refusal information table 130 of FIG. 13 is recommended to users 100 and 101, and the users accept the recommendation content and express participation. In this case, the equipment control means 52 stops air conditioning of rooms of the users 100 and 101 during the wine tasting event and achieves energy saving of the facility.

If the users 100 and 101 do not return to their rooms and have plans to carry out another actions after the users 100 and 101 participate the wine tasting event, the equipment control means 52 stops the air conditioning until the plan ends. The equipment control means 52 starts operation of the air conditioning several minutes to tens of minutes before the users return to their rooms. The environment setting of the users' rooms are therefore set so as to fit the users' taste, and energy saving can be achieved without giving uncomfortableness to the users.

The equipment control means 52 does not set air conditioning and lightning of all rooms at the same level, and sets setting, which is stored in the environment setting storage device 441, close to setting environment at past staying time of a user using the room. As a result, waste of electric power consumption in a facility is not only cut, but comfortableness can be given to a user.

The energy management system of the embodiment of the invention is applied to a situation in which a hotel administrator wants for a user to stay and wants to suppress energy consumption of the whole hotel as much as possible. For example, the administrator recommends events which are held in the hotel or the neighborhood to a user and can achieves energy saving such as reduction of energy usage amount of each room of the hotel if the user carried out the recommended action.

The energy management system of the embodiment of the invention achieves an energy saving effect by recommending users to select action plans which reflect taste of the users and lead to energy saving of the whole facilities as a theme park administrator or an event organizer desires than the users act separately.

Further the energy management system of the embodiment of the invention can be applied to various businesses in which an administrator of electricity and a user thereof are different, like a school, a company, a public facility, an amusement facility, or a smart city.

The invention is described based on the embodiments and exemplary embodiments, but the energy management system of the embodiment of the invention is not limited to the configuration of the embodiment. The invention includes the energy management system in which the configurations of the above embodiments are modified and changed. An energy management method and a program causing a computer to execute the energy management method on the basis of the embodiments of the invention are included in the scope of the invention.

A part or all of the above embodiments can be described as following supplemental notes, but are not limited to the following.

### (Supplemental Note 1)

An energy management system for a facility comprising a plurality of pieces of equipment that consume energy, the energy management system includes an equipment information storage device for storing equipment information pertaining to equipment utilization, an action history storage device for storing action history information of an equipment user, and a recommendation content decision means for calculating, on the basis of the equipment information and the action history information, an action pertaining to the equipment utilization that leads to a reduction in energy consumption at the whole facility, and deciding on recommendation content including the action for the user.

### (Supplemental Note 2)

The energy management system of the supplemental note 1, wherein the recommendation content decision means includes

an energy saving condition calculation means for calculating the number of users who use the facility, on the basis of the equipment information and the action history information, and calculating an operation method of the equipment reducing the amount of energy consumed at the facility,

an energy saving method storage device for storing the operation method,

an action possibility calculation means for calculating action possibility information including action prediction and feasibility of the user on the basis of the action history information,

an action candidate storage device for storing the action possibility information,

an equipment utilization information storage device for storing equipment utilization information indicating correspondence between the equipment in the facility used by the user and action content of the user,

an action decision means for calculating, on the basis of the operation method and the action possibility information, an action pertaining to the equipment utilization that leads to a reduction in energy consumption at the facility.

### (Supplemental Note 3)

The energy management system of the supplemental note 1 or the supplemental note 2, further including,

an action recommendation means for notifying the user of the recommendation content, and

an action input means for acquiring recommendation acceptance/refusal information including information on whether or not the user accepts the recommendation content, and the action history information,

wherein the action input means transmits the action history information and the recommendation acceptance/refusal information to the action history storage device.

### (Supplemental Note 4)

The energy management system of the supplemental note 3, wherein the action input means acquires the action history information by a reader means arranged in the facility.

### (Supplemental Note 5)

The energy management system of the supplemental note 3 or the supplemental note 4, further including,

an equipment information input means for acquiring the equipment information, and

a recommendation result notifying means for acquiring the recommendation acceptance/refusal information stored in the action history storage device, and notifying an administrator of the facility of the recommendation acceptance/refusal information.

### (Supplemental Note 6)

The energy management system of any one of claim 1 to claim 4, comprising:

an individual characteristic analysis means for analyzing an individual characteristic of the user by using the action history information,

an individual characteristic storage device for storing the individual characteristic,

a situation analysis means for analyzing an action that the user does not carries out by using the action history information, and

a stay plan storage device for storing a plan for the user to stay in the facility.

### (Supplemental Note 7)

The energy management system of the supplemental note 6, wherein the individual characteristic analysis means calculates probability that the user carries out the specific action next, using the number of times the user carries out the specific action with acceptance of the recommendation content, which is stored in the action history storage device, and the number of times the user carries out the specific action in all the actions which the user has carried out.

### (Supplemental Note 8)

The energy management system of any one of the supplemental note 2 to the supplemental note 4, including

an energy operation calculation means for calculating an optimum energy operation method for the whole facility,

wherein the energy saving condition calculation means uses the result calculated by the energy operation calculation means.

### (Supplemental Note 9)

The energy management system of any one of the supplemental note 1 to the supplemental note 5, further including,

an environment setting storage device for storing environment setting information at the time of utilization of each piece of equipment by the user, and

an equipment control means for controlling the equipment using the environment setting information,

wherein the energy saving condition calculation means performs calculation using the environment setting information, and the equipment control means controls the relevant equipment depending on the recommendation acceptance/refusal information.

### (Supplemental Note 10)

A server device that performs energy management of a facility comprising a plurality of pieces of equipment that consume energy, including,

an equipment information storage device for storing equipment information pertaining to equipment utilization,

an action history storage device for storing action history information of an equipment user, and

a recommendation content decision means for calculating, on the basis of the equipment information and the action history information, an action pertaining to the equipment utilization that leads to a reduction in energy consumption at the facility, and deciding on recommendation content including the action for the user.

### (Supplemental Note 11)

A terminal device that is connected to the server device of the supplemental note 10 in a communicable manner, including an action recommendation means for notifying the user of the recommendation content.

### (Supplemental Note 12)

The terminal device that is connected to the server device of the supplemental note 10 in a communicable manner, including an action input means for acquiring the action history information, and recommendation acceptance/refusal information including information on whether or not the user accepts the recommendation content.

### (Supplemental Note 12)

The terminal device that is connected to the server device of the supplemental note 10 in a communicable manner, further including,

an action recommendation means for notifying the user of the recommendation content, and

an action input means for acquiring recommendation acceptance/refusal information including information on whether or not the user accepts the recommendation content, and the action history information,

wherein the action input means transmits the action history information and the recommendation acceptance/refusal information to the action history storage device.

### (Supplemental Note 14)

The terminal device that is connected to the server device of the supplemental note 10 in a communicable manner, including an equipment information input means for acquiring equipment information on equipment utilization in the facility.

### (Supplemental Note 15)

The terminal device that is connected to the server device of the supplemental note 10 in a communicable manner, including a recommendation result notifying means for acquiring the recommendation acceptance/refusal information stored in the action history storage device and notifying an administrator of the recommendation acceptance/refusal information.

### (Supplemental Note 16)

The terminal device that is connected to the server device of the supplemental note 10 in a communicable manner, including

an equipment information input means for acquiring the equipment information on the equipment utilization, and

a recommendation result notifying means for acquiring the recommendation acceptance/refusal information stored in the action history storage device, and notifying an administrator of the facility of the recommendation acceptance/refusal information.

### (Supplemental Note 17)

An energy management method of facility comprising a plurality of pieces of equipment that consume energy, the method including,

storing equipment information pertaining to equipment utilization,

storing action history information of an equipment user, and calculating, on the basis of the equipment information and the action history information, an action pertaining to the equipment utilization that leads to a reduction in energy consumption at the facility, and deciding on recommendation content including the action for the user.

### (Supplemental Note 18)

A program causing a computer to execute energy management of a facility including a plurality of pieces of equipment that consume energy, the program causing the computer to execute,

a step of storing equipment information pertaining to equipment utilization,

a step of storing action history information of an equipment user, and

a step of calculating, on the basis of the equipment information and the action history information, an action pertaining to the equipment utilization that leads to a reduction in energy consumption at the facility, and deciding on recommendation content including the action for the user.

This application claims priority from Japanese Patent Application No. 2012-183744 filed on Aug. 23, 2012 and the contents of which are incorporation herein by reference in their entirety.

### REFERENCE SIGNS LIST

1 Management terminal device
2 User terminal device
4 Server device
5 Control terminal device
11 Equipment information input means
12 Recommendation result notifying means
21 Action recommendation means
31 Action input means
41 Equipment information storage device
42 Action history storage device
43 Recommendation content decision means
51 Energy operation calculation means
52 Equipment control means
60 Energy utilization information table
70 Priority information table
80 Action history information table
90 Action feasibility information table
100 Equipment utilization information table
110 Equipment feasibility information table
120 Action recommendation information table
130 Recommendation acceptance/refusal information table
140 Action feasibility information table
150 Stay history information table
160 Stay history detailed information table
171 Integrated management board
173 Center server
174 Control panel
180 Recommend unit
181 Input data
182 Prior probability
183 Gap Markov model
184 Weight
185 Input data reading unit
186 Extended Markov model reading unit
187 Weight reading unit
188 Maximum commodity selection unit
189 Recommend output unit
191 Air conditioning management device
192 Setter
193 Electric power integrating device
195 Indoor unit
200 Environment management device
201 Environment information acquiring unit
203 Visitor information acquiring unit
206 Environmental management information generating unit
217 Display control unit
223 Display device
431 Energy saving condition calculation means
432 Energy saving method storage device
433 Equipment utilization information storage device
434 action possibility calculation means
435 action candidate storage device
436 Action decision means
437 Situation analysis means
438 Individual characteristic analysis means
439 Individual characteristic storage device
440 Stay plan storage device
441 Environment setting storage device

1. An energy management system for a facility comprising a plurality of pieces of equipment that consume energy, the energy management system comprising:
an equipment information storage device for storing equipment information pertaining to equipment utilization;
an action history storage device for storing action history information of an equipment user; and
a recommendation content decision unit which calculates, on the basis of the equipment information and the action history information, an action pertaining to the equipment utilization that leads to a reduction in energy consumption at the whole facility, and decides on a recommendation content including the action for the user.

2. The energy management system of claim 1, wherein the recommendation content decision unit comprises:
an energy saving condition calculation unit which calculates the number of users who use the facility, on the basis of the equipment information and the action history information, and calculates an operation method for the equipment reducing energy consumption at the whole facility;
an energy saving method storage device for storing the operation method;
an action possibility calculation unit which calculates action possibility information including action prediction and feasibility of the user on the basis of the action history information;
an action candidate storage device for storing the action possibility information;
an equipment utilization information storage device for storing equipment utilization information indicating correspondence between the equipment in the facility used by the user and an action content of the user;
an action decision unit which calculates, on the basis of the operation method and the action possibility information, an action pertaining to the equipment utilization that leads to a reduction in energy consumption at the facility.

3. The energy management system of claim 2, further comprising:
an action recommendation unit which notifies the user of the recommendation content; and
an action input unit which acquires recommendation acceptance/refusal information including information on whether or not the user accepts the recommendation content, and the action history information,
wherein the action input unit transmits the action history information and the recommendation acceptance/refusal information to the action history storage device.

4. The energy management system of claim 3, further comprising:
an equipment information input unit which acquires the equipment information; and
a recommendation result notifying unit which acquires the recommendation acceptance/refusal information stored in the action history storage device, and notifies an administrator of the facility of the recommendation acceptance/refusal information.

5. The energy management system of claim 4, comprising:
an individual characteristic analysis unit which analyzes an individual characteristic of the user by using the action history information;
an individual characteristic storage device for storing the individual characteristic;
a situation analysis unit which analyzes an action that the user does not carries out by using the action history information; and
a stay plan storage device for storing a plan for the user to stay in the facility.

6. The energy management system of claim 2, further comprising:
an energy operation calculation unit which calculates for calculating an optimum energy operation method for the whole facility, wherein the energy saving condition calculation unit uses the result calculated by the energy operation calculation unit.

7. The energy management system of claim 3, further comprising:
an environment setting storage device for storing environment setting information at the time of utilization of each piece of equipment by the user; and
an equipment control unit which controls the equipment using the environment setting information,
wherein the energy saving condition calculation unit performs calculation using the environment setting information, and the equipment control unit controls the relevant equipment depending on the recommendation acceptance/refusal information.

8. A server device that performs energy management of a facility comprising a plurality of pieces of equipment that consume energy, comprising:
an equipment information storage device for storing equipment information pertaining to equipment utilization;
an action history storage device for storing action history information of an equipment user; and
a recommendation content decision unit which calculates, on the basis of the equipment information and the action history information, an action pertaining to the equipment utilization that leads to a reduction in energy consumption at the facility, and decides on recommendation content including the action for the user.

9. A terminal device that is connected to the server device of claim 8 in a communicable manner, the device comprising:
an equipment information input unit which acquires the equipment information pertaining to equipment utilization; and
a recommendation result notifying unit which acquires the recommendation acceptance/refusal information including information on whether or not the user accepts the recommendation content, and notifies an administrator of the facility of the recommendation acceptance/refusal information.

10. An energy management method of a facility comprising a plurality of pieces of equipment that consume energy, the method comprising:
storing equipment information pertaining to the equipment utilization;
storing action history information of the equipment user; and
calculating, on the basis of the equipment information and the action history information, an action pertaining to the equipment utilization that leads to a reduction in energy consumption at the facility, and deciding on recommendation content including the action for the user.

11. The energy management system of claim 1, further comprising:
an action recommendation unit which notifies the user of the recommendation content; and
an action input unit which acquires recommendation acceptance/refusal information including information on whether or not the user accepts the recommendation content, and the action history information, wherein the action input unit transmits the action history information and the recommendation acceptance/refusal information to the action history storage device.

12. The energy management system of claim 1, comprising:
an individual characteristic analysis unit which analyzes an individual characteristic of the user by using the action history information;
an individual characteristic storage device for storing the individual characteristic;
a situation analysis unit which analyzes an action that the user does not carries out by using the action history information; and
a stay plan storage device for storing a plan for the user to stay in the facility.

13. The energy management system of claim 2, comprising:
an individual characteristic analysis unit which analyzes an individual characteristic of the user by using the action history information;
an individual characteristic storage device for storing the individual characteristic;
a situation analysis unit which analyzes an action that the user does not carries out by using the action history information; and
a stay plan storage device for storing a plan for the user to stay in the facility.

14. The energy management system of claim 3, comprising:
an individual characteristic analysis unit which analyzes an individual characteristic of the user by using the action history information;
an individual characteristic storage device for storing the individual characteristic;
a situation analysis unit which analyzes an action that the user does not carries out by using the action history information; and
a stay plan storage device for storing a plan for the user to stay in the facility.

15. The energy management system of claim 3, further comprising:
an energy operation calculation unit which calculates for calculating an optimum energy operation method for the whole facility,
wherein the energy saving condition calculation unit uses the result calculated by the energy operation calculation unit.

16. The energy management system of claim 4, further comprising:
an environment setting storage device for storing environment setting information at the time of utilization of each piece of equipment by the user; and
an equipment control unit which controls the equipment using the environment setting information, wherein the energy saving condition calculation unit performs calculation using the environment setting information, and the equipment control unit controls the relevant equipment depending on the recommendation acceptance/refusal information.

17. The energy management system of claim 11, further comprising:
an equipment information input unit which acquires the equipment information; and
a recommendation result notifying unit which acquires the recommendation acceptance/refusal information stored in the action history storage device, and notifies an administrator of the facility of the recommendation acceptance/refusal information.

18. The energy management system of claim 11, comprising:
an individual characteristic analysis unit which analyzes an individual characteristic of the user by using the action history information;
an individual characteristic storage device for storing the individual characteristic;
a situation analysis unit which analyzes an action that the user does not carries out by using the action history information; and
a stay plan storage device for storing a plan for the user to stay in the facility.

19. The energy management system of claim 11, further comprising:
an energy operation calculation unit which calculates for calculating an optimum energy operation method for the whole facility,
wherein the energy saving condition calculation unit uses the result calculated by the energy operation calculation unit.

20. The energy management system of claim 11, further comprising:
an environment setting storage device for storing environment setting information at the time of utilization of each piece of equipment by the user; and
an equipment control unit which controls the equipment using the environment setting information, wherein the energy saving condition calculation unit performs calculation using the environment setting information, and the equipment control unit controls the relevant equipment depending on the recommendation acceptance/refusal information.
